(19) United States
(12) Patent Application Publication
(10) Pub. No.: US 2007/0232693 A1
(43) Pub. Date: Oct. 4, 2007

(54) COMPOSITIONS FOR TREATING INFESTATION OF PLANTS BY PHYTOPATHOGENIC MICROORGANISMS

(75) Inventor: Ibrahim Abou-Nemeh, Lake St. Louis, MO (US)

Correspondence Address: POLSINELLI SHALTON FLANIGAN SUELTHAUS PC, 700 W. 47TH STREET, SUITE 1000, KANSAS CITY, MO, 64112-1802, US

(73) Assignee: NOVUS INTERNATIONAL, INC., St. Louis, MO (US)

(21) Appl. No.: 11/691,658

(22) Filed: Mar. 27, 2007

Related U.S. Application Data
(60) Provisional application No. 60/786,753, filed on Mar. 28, 2006.

(51) Int. Cl. A01N 55/02; A01N 37/12; A01N 37/44

(52) U.S. Cl. 514/492; 514/562; 514/499; 514/494; 514/501

(57) ABSTRACT

The present invention provides compositions and methods for treating the infestation of plants or progeny of plants by phytopathogenic microorganisms. The anti-phytopathogenic microbial compositions are generally effective against of broad spectrum of microbes, such as fungi, yeast and bacteria. Because of their broad spectrum of efficacy, the anti-phytopathogenic microbial compositions may be utilized to treat or prevent pathogenic infestation of a multitude of plants.

### CROSS-REFERENCE TO RELATED APPLICATION

This application claims priority to U.S. Provisional Application Ser. No. 60/786,753 filed on Mar. 28, 2006, which is hereby incorporated by reference in its entirety.

### FIELD OF THE INVENTION

The present invention provides compositions and methods for treating the infestation of plants or progeny of plants by phytopathogenic microorganisms.

### BACKGROUND OF THE INVENTION

The control of phytopathogenic microorganisms, and in particular, fungi is of vast economic importance since fungal growth on plants or on parts of plants inhibits production of foliage, fruit or seed, and the overall quality of a cultivated crop. Because of the economic ramifications of fungal propagation in agricultural and horticultural cultivations, a broad spectrum of fungicidal and fungi static products have been developed for general and specific applications. Fungicides can be separated into two categories: protectants and systemics. Protectant fungicides, as the name implies, protect the plant against infection at the site of application, but do not penetrate into the plant. Conversely, systemic fungicides prevent disease from developing on parts of the plant that are remote from the site of application of the fungicide.

Inorganic fungicides were generally the first to be used in large-scale crop protection aimed against pathogenic fungi. Notable among these are elemental sulfur applied in powder form, and copper sulfate applied in caustic calcium aqueous mixture. While these inorganic fungicides are generally effective, they have significant drawbacks. The fungicides or derivatives of the fungicides are often environmentally non-recyclable. Additionally, pathogens often develop resistance to synthetic pesticides. Because of the development of resistance, continuous endeavors are needed to develop new crop protecting agents.

A variety of simple structured anti-pathogenic compounds have been developed. Notable among these are fungicide compositions based on copper, zinc or manganese that have been shown to be effective against a broad range of plant pathogenic fungi and bacteria. Fungicides in this category, unlike the category of inorganic fungicides previously discussed, are generally environmentally friendly and the microbes tend to not develop immunity against them. In certain applications, however, the use of these traditional inorganic fungicides for soil treatment is limited due to the absorption of the metal ions to soil particles.

A need, therefore, remains for anti-phytopathogenic microbial compositions that are environmentally safe, cost affordable, and that are highly effective for controlling a broad spectrum of plant microbes, such as fungi, yeast and bacteria.

### SUMMARY OF THE INVENTION

Accordingly, one aspect of the invention encompasses a method for treating infestation of a plant or its progeny by a phytopathogenic microorganism. The method comprises applying a metal chelate or a metal salt, the metal chelate or metal salt comprising metal ions and a hydroxy analog of methionine, to the plant.

Another aspect of the invention provides a method for treating a foliar fungal disease of a legume plant. The method comprises applying a copper chelate of 2-hydroxy-4(methylthio)butanoic acid to the leaves of the legume plant.

Other aspects and features of the invention will be in part apparent and in part pointed out hereinafter.

### REFERENCE TO COLOR FIGURES

The application file contains at least one photograph executed in color. Copies of this patent application publication with color photographs will be provided by the Office upon request and payment of the necessary fee.

### BRIEF DESCRIPTION OF THE DRAWINGS

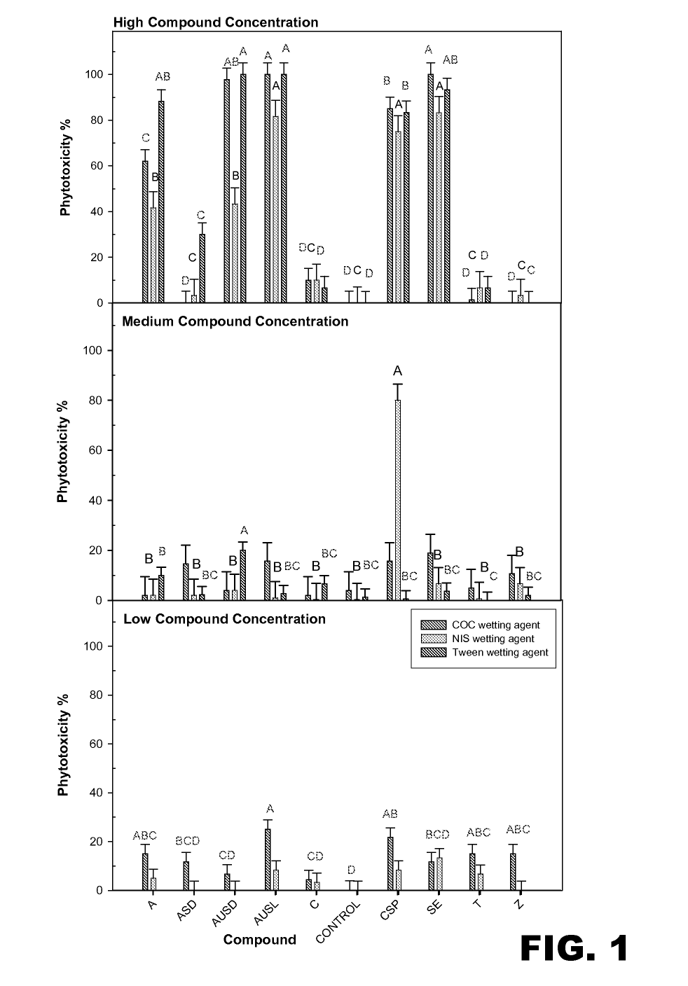

FIG. 1 depicts bar graphs illustrating the extent of phytotoxicity in the absence or presence of high, medium, or low concentrations of fungicidal compounds (identified in Table 1). The compounds were applied in the presence of one of three different wetting agents (COC, NIS, or Tween). Control was the application of each wetting agent alone. Mean and standard error are presented. The letter superscripts represent statistical differences (P=0.05) among the compound means; the letters were generated by the Duncan routine (Steel et al., Principles and Procedures of Statistics—A Biometrical Approach, 3rd Ed., 1997, McGraw-Hill Series) to determine the statistical significance between treatments. Treatments with the same letters are not significantly different.

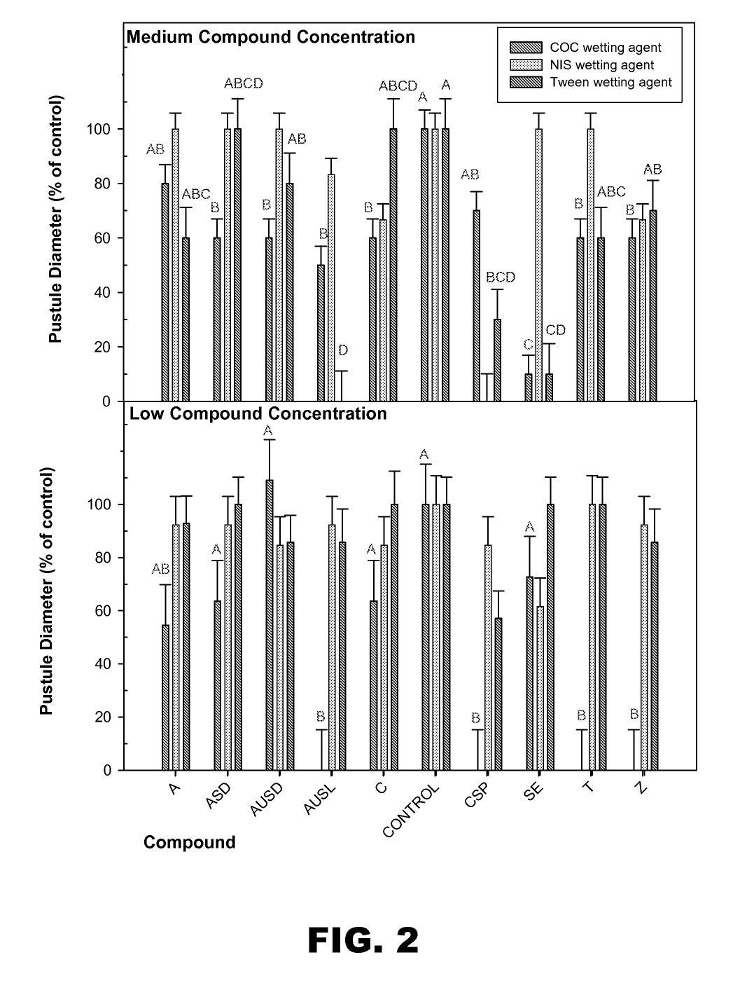

FIG. 2 presents graphs illustrating the diameter of rust pustules in the absence or presence of medium or low concentrations of fungicidal compounds, applied in the presence of one of the three wetting agents (COC, NIS, or Tween). Control was the application of each wetting agent alone. Pustule diameter ratings ranged from no evidence of infection (0%) to >800 μm (100%). Mean and standard error are presented. The letter superscripts represent statistical differences (P=0.05) among the compound means; the letters were generated by the Duncan routine to determine the statistical significance between treatments. Treatments with the same letters are not significantly different.

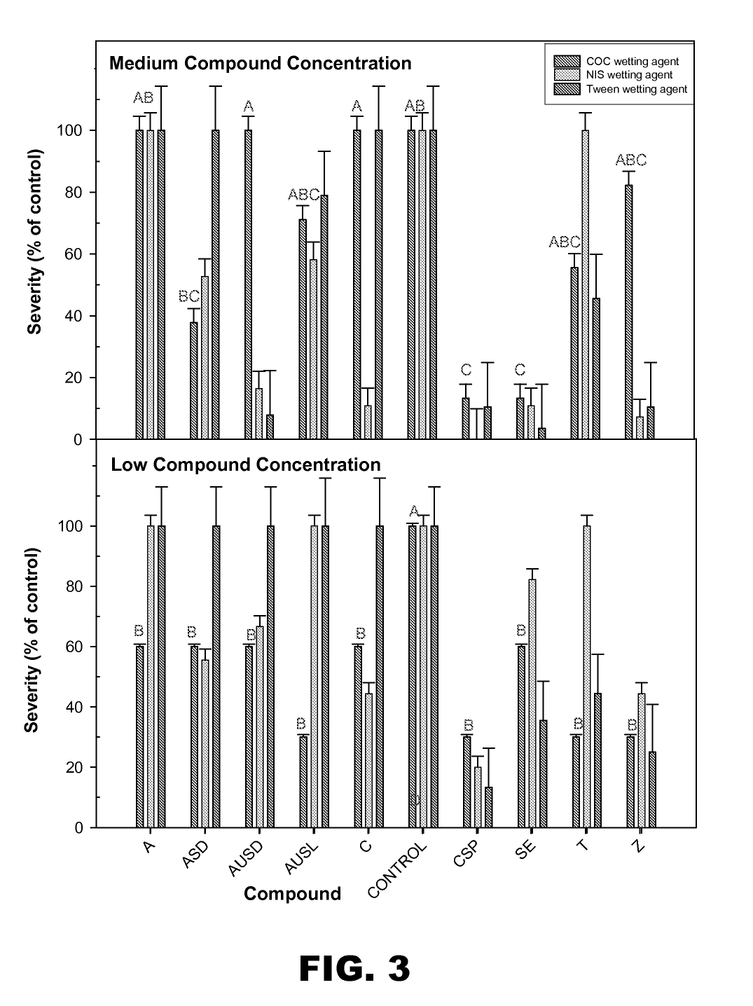

FIG. 3 depicts graphs illustrating the severity of rust infection in the absence or presence of medium or low concentrations of fungicidal compounds, applied in the presence of one of the three wetting agents (COC, NIS, or Tween). Control was the application of each wetting agent alone. Severity was assessed by the number of pustules per leaf. Mean and standard error are presented. The letter superscripts represent statistical differences (P=0.05) among the compound means; the letters were generated by the Duncan routine to determine the statistical significance between treatments. Treatments with the same letters are not significantly different.

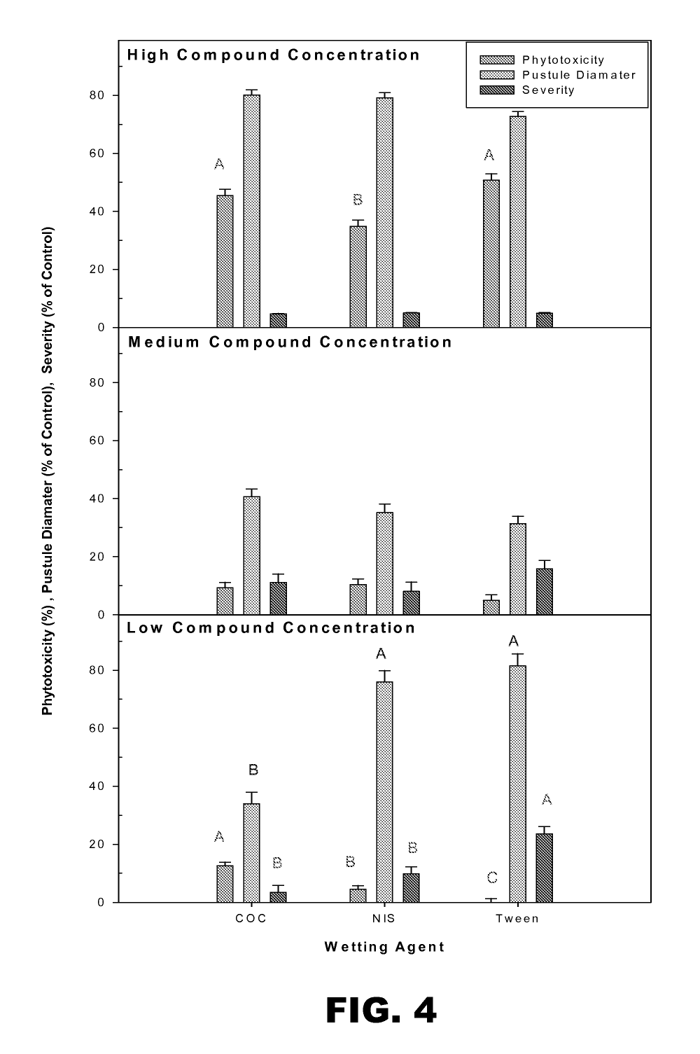

FIG. 4 presents bar graphs illustrating the effects of high, medium, or low concentrations of fungicidal compounds as a function of wetting agent. Mean and standard error of phytotoxicity, pustule diameter, and severity are presented. The letter superscripts represent statistical differences (P=0.05) among the compound means; the letters were generated by the Duncan routine to determine the statistical significance between treatments. Treatments with the same letters are not significantly.

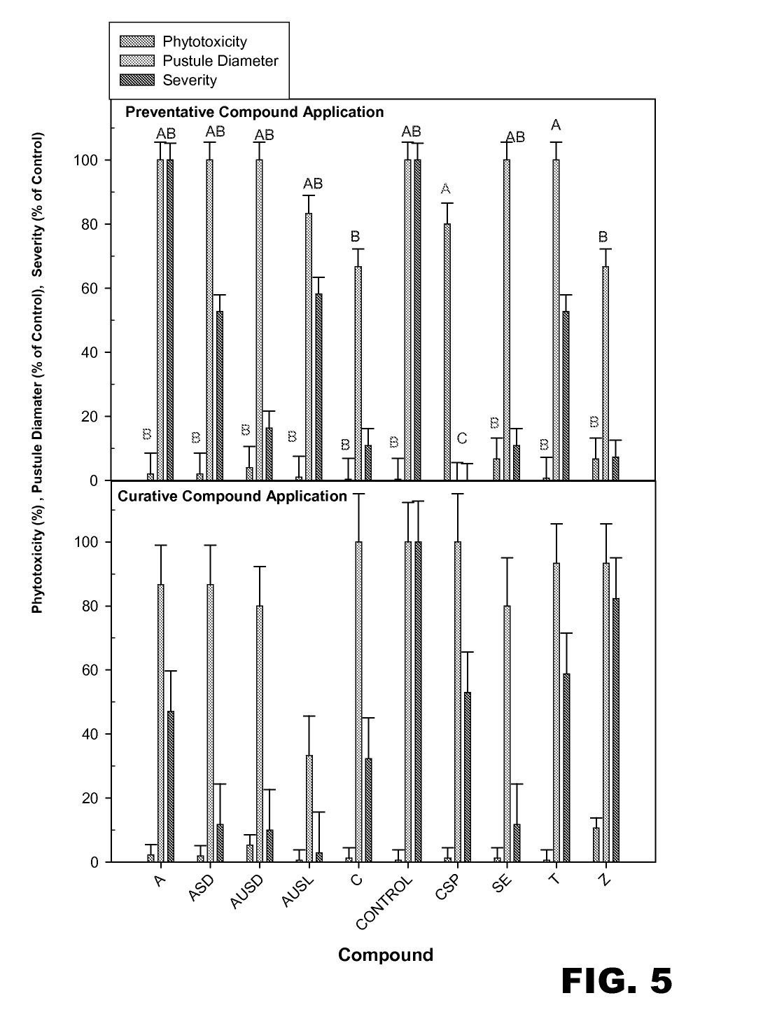

FIG. 5 depicts graphs illustrating the efficacy of medium concentrations of fungicidal compounds to prevent or cure rust in beans. Control was the application of each wetting agent alone. Mean and standard error of phytotoxicity, pustule diameter, and severity are presented. The letter superscripts represent statistical differences (P=0.05) among the compound means; the letters were generated by the Duncan routine to determine the statistical significance between treatments. Treatments with the same letters are not significantly.

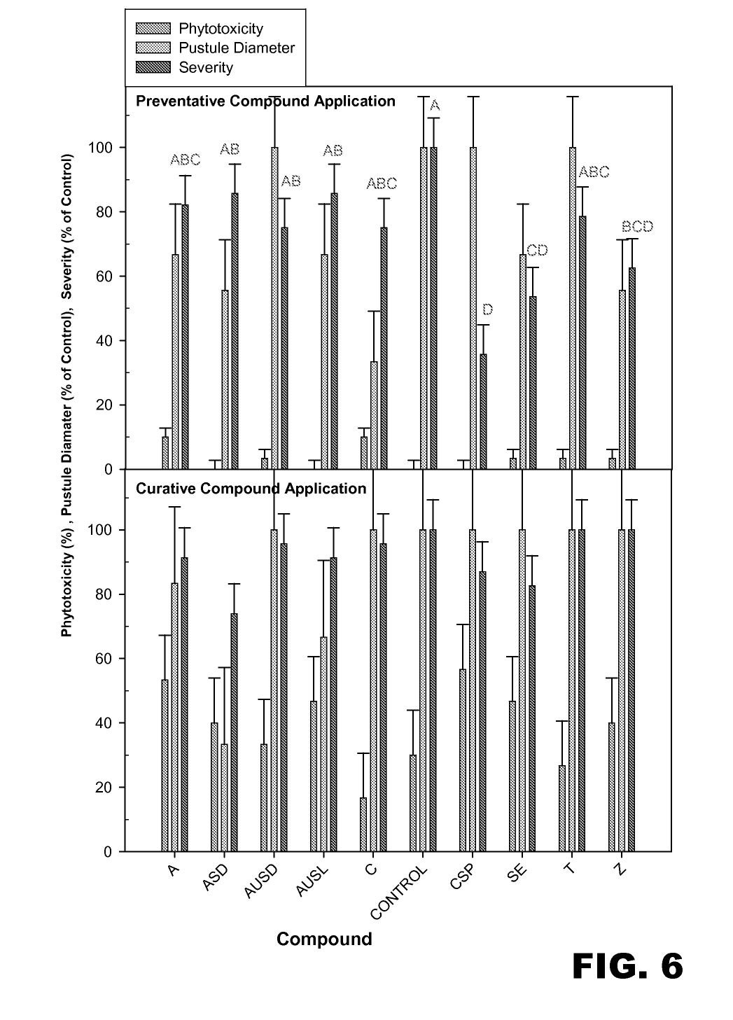

FIG. 6 depicts graphs illustrating the efficacy of medium concentrations of fungicidal compounds to prevent or cure rust in wheat. Control was the application of each wetting agent alone. Mean and standard error of phytotoxicity, pustule diameter, and severity are presented. The letter superscripts represent statistical differences (P=0.05) among the compound means; the letters were generated by the Duncan routine to determine the statistical significance between treatments. Treatments with the same letters are not significantly different.

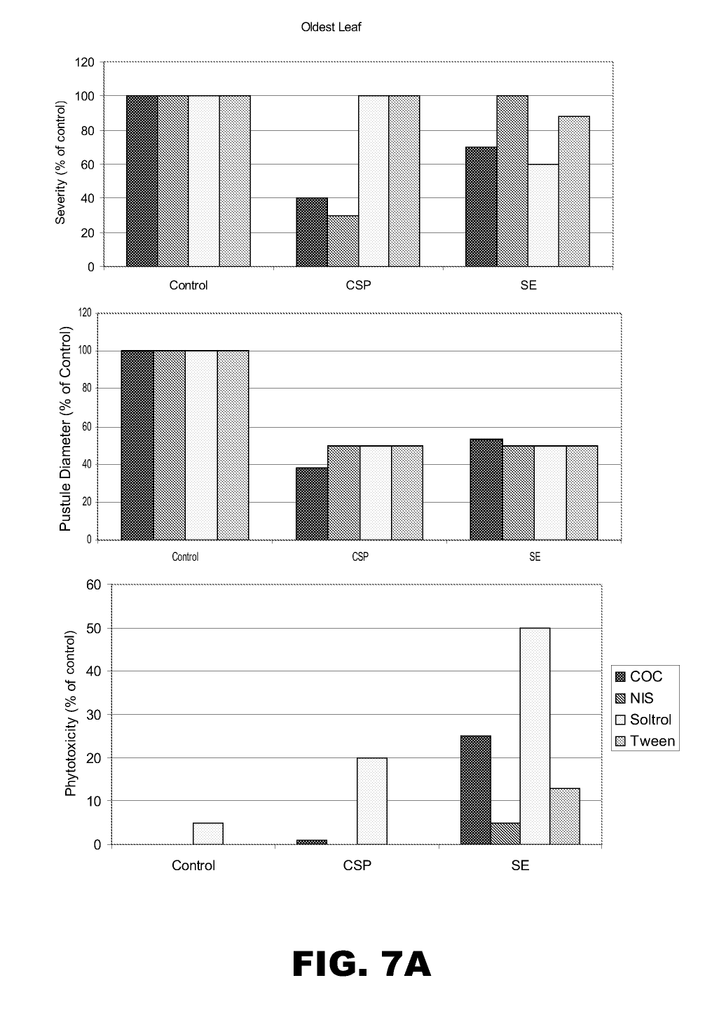

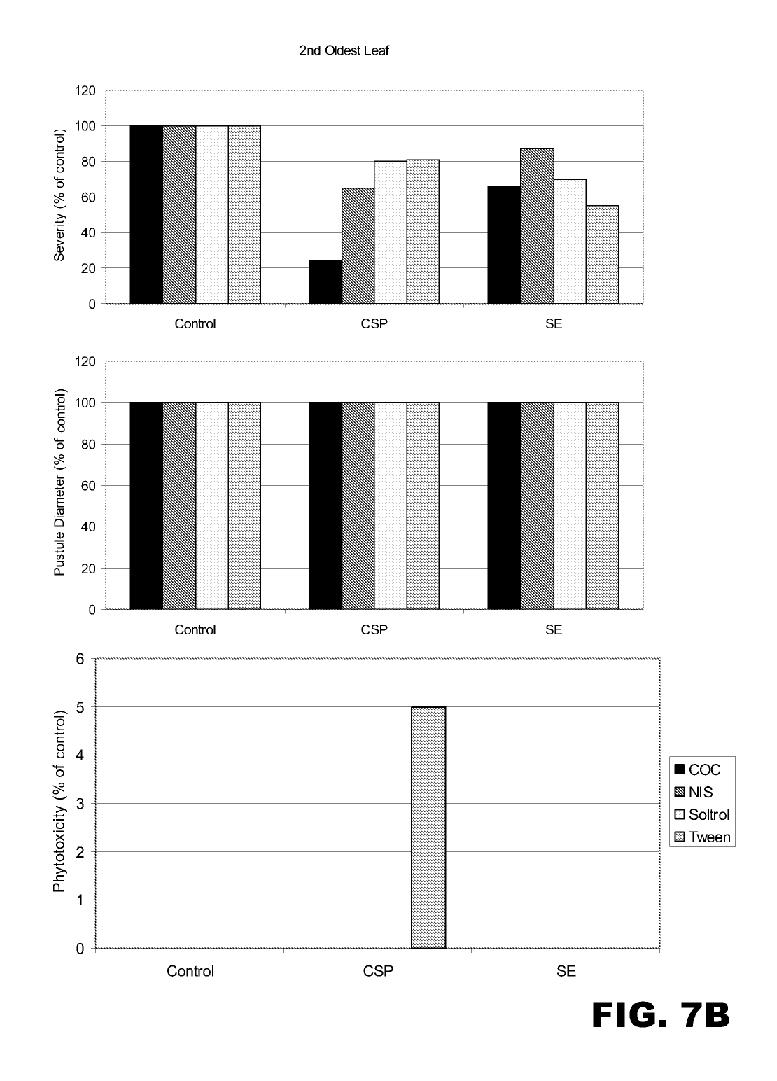

FIG. 7 presents bar graphs illustrating the efficacy of two fungicidal compounds in preventing rust in dry beans. The compounds were applied in the presence of one of four different wetting agents (COC, NIS, Soltrol, or Tween). Control was the application of each wetting agent alone. Mean of phytotoxicity, pustule diameter, and severity are presented. Panel A presents data from the oldest leaf on each plant (which was inoculated), and Panel B presents data from the second oldest leaf (which was not inoculated, but rather infected secondarily).

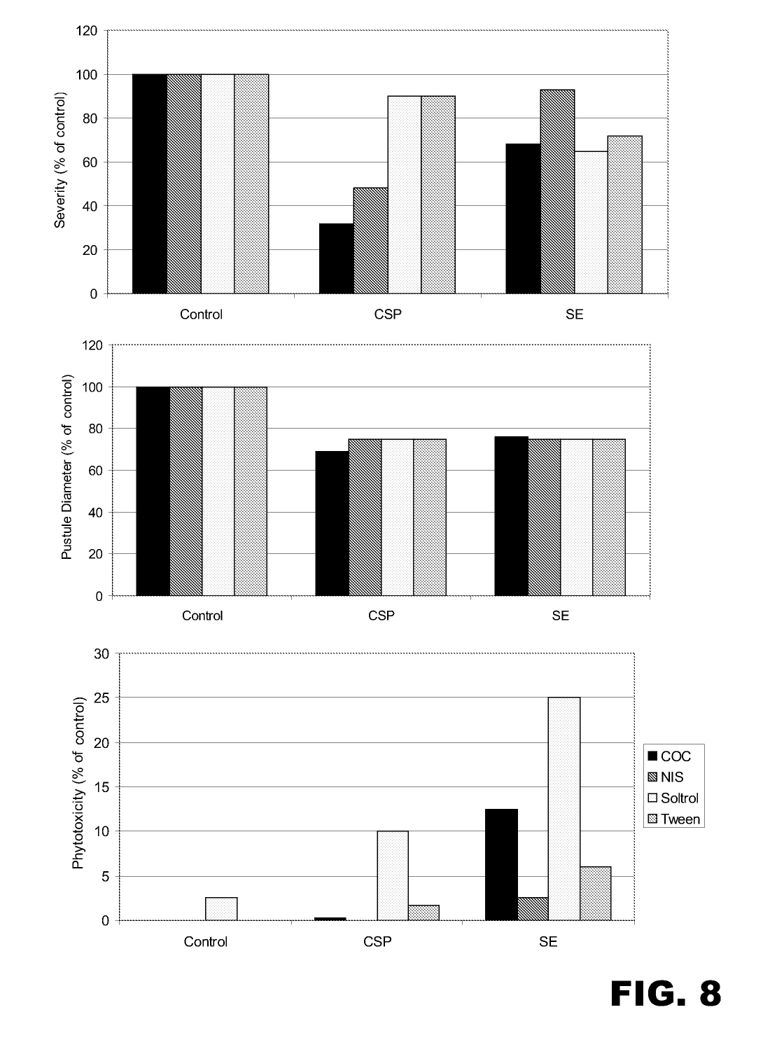

FIG. 8 depicts bar graphs illustrating the efficacy of two fungicidal compounds in curing rust in beans. The compounds were applied in the presence of one of four different wetting agents (COC, NIS, Soltrol, or Tween). Control was the application of each wetting agent alone. Mean of phytotoxicity, pustule diameter, and severity are presented.

### DETAILED DESCRIPTION OF THE PREFERRED EMBODIMENTS

It has been discovered that quinoline compounds, such as 6-ethoxy-1,2-dihydro-2,2,4-trimethylquinoline, function as anti-microbial agents when applied to plants or their progeny. It has also been discovered that hydroxy analogs of methionine and metal chelates of hydroxy analogs of methionine function as anti-microbial agents when applied to plants or their progeny. Advantageously, by combining both types of compounds, as detailed in the examples, certain combinations of compounds have been discovered that unexpectedly act in a synergistic manner. In this context, the phrase “synergistic” means that the combination of certain compounds together provide enhanced anti-microbial activity compared to either compound of the combination acting alone. The anti-phytopathogenic microbial compositions are generally effective against a broad spectrum of microbes, such as fungi, yeast and bacteria. Because of their broad spectrum of efficacy, the anti-phytopathogenic microbial compositions may be utilized to treat or prevent infestation of a multitude of plants by pathogenic microbes.

I. Anti-Phytopathenogen Microbial Compositions

One aspect of the invention encompasses compositions that may be utilized to treat or prevent infestation of a plant or its progeny by phytopathenogenic microorganisms. Typically the composition may comprise a quinoline compound; a compound having an organic acid and an organic sulfur; or a combination comprising a quinoline compound and a compound having an organic acid and an organic sulfur. In this context, the term “composition” when referring to a composition having more than one active compound, is used in its broadest sense to describe use of two separate compounds to treat or prevent infestation of a plant or its progeny by phytopathenogenic microorganisms. The term composition does not mean that the two compounds have to be applied to the plant at the same time as a part of the same application. It is contemplated for example, as described below, that the quinoline compound and compound having an organic acid and an organic sulfur may be applied to the plant either simultaneously as part of the same mixture or applied sequentially, one compound after the other. As will be appreciated by a skilled artisan, the anti-phytopathenogenic microbial compositions may optionally include a variety of other agents without departing from the scope of the invention. The agents, for example, may be additional agents having anti-microbial activity, that when combined, produce a synergistic anti-microbial effect. Alternatively, the additional agent may include a compounds that increase the effectiveness of the compositions of the invention, such as wetting agents. Suitable non-limiting examples of agents comprising compositions of the invention are detailed below.

(a) Quinoline Compounds

The composition may optionally include a quinoline compound having anti-phytopathogenic microbial activity. Typically, the quinoline compound will be a substituted 1,2-dihydroquinoline. Substituted 1,2-dihydroquinoline compounds suitable for use in the invention generally correspond to formula (I):

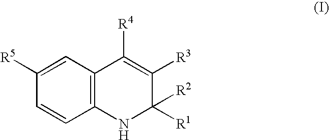

wherein:
R¹, R², R³ and R⁴ are independently selected from the group consisting of hydrogen and an alkyl group having from 1 to about 6 carbons; and
R⁵ is an alkoxy group having from 1 to about 12 carbons.

In another embodiment, the substituted 1,2-dihydroquinoline will have formula (I) wherein:
R¹, R², R³ and R⁴ are independently selected from the group consisting of hydrogen and an alkyl group having from 1 to about 4 carbons; and
R⁵ is an alkoxy group having from 1 to about 4 carbons.

In one preferred embodiment, the substituted 1,2-dihydroquinoline will be 6-ethoxy-1,2-dihydro-2,2,4-trimethylquinoline having the formula:

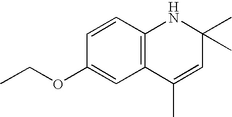

The compound, 6-ethoxy-1,2-dihydro-2,2,4-trimethylquinoline, commonly known as ethoxyquin, is sold under the trademark SANTOQUIN®. The present invention also encompasses salts of ethoxyquin and other compounds having formula (I). Ethoxyquin and other compounds having formula (I) may be purchased commercially from Novus International, Inc. or made in accordance with methods generally known in the art, for example, as detailed in U.S. Pat. No. 4,772,710, which is hereby incorporated by reference in its entirety.

Typically, in each embodiment described herein, the substituted 1,2-dihydroquinoline compound may be formulated as a liquid, powder or emulsion and applied to the plant, as described in more detail below. A suitable example of an emulsion formulation comprises approximately 70% by weight 6-ethoxy-1,2-dihydro-2,2,4-trimethylquinoline, approximately 23% by weight water, approximately 5% by weight. Tween and approximately 2% by weight myverol 18-19.

(b) Compounds having an Organic Acid and an Organic Sulfur

A further aspect of the invention provides compositions that optionally include a compound comprising an organic acid moiety and an organic sulfur moiety, which typically together impart anti-microbial activity to the compound. In one exemplary embodiment, the compound is a hydroxy analog of methionine. In one embodiment, the hydroxy analog of methionine is a compound having formula (II)

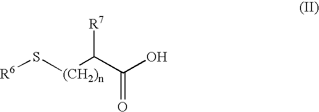

wherein:

n is an integer from 0 to 2;

R⁶ is methyl of ethyl; and

R⁷ is hydroxyl or amino.

In a further exemplary embodiment for compounds having formula (II), n is 2, R⁶ is methyl and R⁷ is hydroxyl. The compound formed by this selection of chemical groups is 2-hydroxy-4(methylthio)butanoic acid (commonly known as “HMTBA” and sold by Novus International, St. Louis, Mo. under the trade name Alimet®). A variety of HMTBA salts, chelates, esters, amides, and oligomers are also suitable for use in the invention. Representative salts of HMTBA, in addition to the ones described below, include the ammonium salt, the stoichiometric and hyperstoichiometric alkaline earth metal salts (e.g., magnesium and calcium), the stoichiometric and hyperstoichiometric alkali metal salts (e.g., lithium, sodium, and potassium), and the stoichiometric and hyperstoichiometric zinc salt. Representative esters of HMTBA include the methyl, ethyl, 2-propyl, butyl, and 3-methylbutyl esters of HMTBA. Representative amides of HMTBA include methylamide, dimethylamide, ethylmethylamide, butylamide, dibutylamide, and butylmethylamide. Representative oligomers of HMTBA include its dimers, trimers, tetramers and oligomers that include a greater number of repeating units.

Alternatively, the hydroxy analog of methionine may be a metal chelate comprising one or more ligand compounds having formula (II) together with one or more metal ions. Irrespective of the embodiment, suitable non-limiting examples of metal ions include zinc ions, copper ions, manganese ions, iron ions, chromium ions, cobalt ions, and calcium ions. In one embodiment, the metal ion is divalent. Examples of divalent metal ions (i.e., ions having a net charge of 2⁺) include copper ions, manganese ions, chromium ions, calcium ions, cobalt ions and iron ions. In another embodiment, the metal ion is zinc. In yet another embodiment, the metal ion is copper. In still another embodiment, the metal ion is manganese. In each embodiment, the ligand compound having formula (II) is preferably HMTBA. In one exemplary embodiment, the metal chelate is HMTBA-Mn. In a further exemplary embodiment, the metal chelate is HMTBA-Cu. In an alternative exemplary embodiment, the metal chelate is HMTBA-Zn.

As will be appreciated by a skilled artisan, the ratio of ligands to metal ions forming a metal chelate compound can and will vary. Generally speaking, where the number of ligands is equal to the charge of the metal ions, the charge of the molecule is typically net neutral because the carboxy moieties of the ligands having formula (II) are in deprotonated form. By way of further example, in a chelate species where the metal ion carries a charge of 2+ and the ligand to metal ion ratio is 2:1, each of the hydroxyl or amino groups (i.e., R⁷ of compound II) is believed to be bound by a coordinate covalent bond to the metal while an ionic bond exists between each of the carboxylate groups of the metal ion. This situation exists, for example, where divalent zinc, copper, or manganese is complexed with two HMTBA ligands. By way of further example, where the number of ligands exceeds the charge on the metal ion, such as in a 3:1 chelate of a divalent metal ion, the ligands in excess of the charge generally remain in a protonated state to balance the charge. Conversely, where the positive charge on the metal ion exceeds the number of ligands, the charge may be balanced by the presence of another anion, such as, for example, chloride, bromide, iodide, bicarbonate, hydrogen sulfate, and dihydrogen phosphate.

Generally speaking, a suitable ratio of ligand to metal ion is from about 1:1 to about 3:1 or higher. In another embodiment, the ratio of ligand to metal ion is from about 1.5:1 to about 2.5:1. Of course within a given mixture of metal chelate compounds, the mixture will include compounds having different ratios of ligand to metal ion. For example, a composition of metal chelate compounds may have species with ratios of ligand to metal ion that include 1:1, 1.5:1, 2:1, 2.5:1, and 3:1.

Metal chelate compounds of the invention may be made in accordance with methods generally known in the art, such as described in U.S. Pat. Nos. 4,335,257 and 4,579,962, which are both hereby incorporated by reference in their entirety. In a preferred process for the preparation of metal chelate compounds, a metal source compound, such as a metal oxide, a metal carbonate, or a metal hydroxide is charged to a reaction vessel, and an aqueous solution of HMTBA is added to the source compound. The concentration of HMTBA in the aqueous solution is typically about 40% to about 89% by weight. The reaction typically proceeds for a period of two hours under moderate agitation. Depending on the starting material used in the reaction, typically water and/or carbon dioxide are produced. Ordinarily, the reaction may be conducted at atmospheric pressure, and the reaction mass is heated to a temperature ranging from about 90° C. to about 130° C. After the reaction is substantially complete, heating of the reaction mass is continued in the reaction vessel to produce a substantially dried product. Typically, the free water content is reduced to about 2% by weight, and the product mass transitions to free-flowing particulate solid. The dried metal chelate product may optionally be mixed with a calcium bentonite filer and ground to a powder. Alternatively, the metal chelate compounds may be purchased from a commercially available source. For example, HMTBA-Zn and HMTBA-Cu may be purchased from Novus International, Saint Louis, Mo., sold under the trade names MINTREX® Zn, and MINTREX® Cu, respectively.

In an alternative exemplary embodiment, the hydroxy analog of methionine may be a metal salt comprising an anionic compound having formula (II) together with a metal ion. Typically, suitable metal ions will have either a 1⁺, 2⁺ or a 3⁺ charge and will be selected from zinc ions, copper ions, manganese ions, iron ions, chromium ions, silver ions, cobalt ions, and silver ions. Without being bound by any particular theory, however, it is generally believed that combinations of zinc, copper, manganese, iron, chromium, nickel, and cobalt ions together with HMTBA form metal chelates as opposed to salts. Irrespective or whether the molecule formed is a salt or a chelate, both forms of the molecules are included within the scope of the invention. Salts useful in the invention may be formed when the metal, metal oxide, metal hydroxide or metal salt (e.g., metal carbonate, metal nitrate, or metal halide) react with one or more compounds having formula (II). In an exemplary embodiment, the compound having formula (II) will be HMTBA.

Salts may be prepared according to methods generally known in the art. For example, a metal salt may be formed by contacting HMTBA with a metal ion source. In one embodiment, a silver ion having a 1⁺ charge may be contacted with HMTBA to form a silver 2-hydroxy-4-methylthiobutanoate metal salt. This salt generally will have a silver to HMTBA ratio of approximately 1:1.

(c) Formulations of Active Compounds

Suitable active compounds for use in the anti-phytopathenogen microbial compositions of the invention include any of the quinoline compounds and any of the compounds having an organic acid and an organic sulfur detailed herein. In some embodiments, the composition may include one active compound. In other embodiments, the composition may include two active compounds. In additional embodiments, the composition may include more than two active compounds. Non-limiting examples of suitable compositions of the invention are set-forth in Table A (i.e., active compounds in column one, if any, are combined with active compounds in column two, if any, to form a composition of the invention).

TABLE A

| ACTIVE COMPOUND(S) 1 | ACTIVE COMPOUND(S) 2 |
|---|---|
| A compound having formula (I) | A compound having formula (II) |
| A compound having formula (I) | No other active compound |
| A compound having formula (I) | HMTBA |
| A compound having formula (I) | HMTBA-Zn |
| A compound having formula (I) | HMTBA-Cu |
| Ethoxyquin | No other active compound |
| Ethoxyquin | HMTBA |
| Ethoxyquin | HMTBA-Zn |
| Ethoxyquin | HMTBA-Cu |
| Ethoxyquin | A compound having formula (II) |
| No other active compound | A compound having formula (II) |
| No other active compound | HMTBA |
| No other active compound | HMTBA-Zn |
| No other active compound | HMTBA-Cu |
| Ethoxyquin | HMTBA and HMTBA-Cu |
| Ethoxyquin | HMTBA and HMTBA-Zn |
| Ethoxyquin | HMTBA, HMTBA-Cu, HMTBA-Zn |
| Ethoxyquin | HMTBA-Zn and HMTBA-Cu |
| HTMBA | HMTBA-Cu |
| HMTBA | HMTBA-Zn |
| HMTBA | HMTBA-Zn and HMTBA-Cu |
| HMTBA-Zn | HMTBA-Cu |

In one exemplary embodiment, the composition of the invention provides copper-containing compounds that are effective for treating the infestation of plants by phytopathogenic microorganisms, and yet, minimize the degree of phytotoxicity for the plant itself. Generally speaking, copper ions are toxic to microorganisms because of their ability to destroy proteins in plant tissues. Because copper can kill all types of plant tissues, however, the use of copper compounds generally carries the risk of injuring foliage and fruit of the plant in order to achieve the antimicrobial benefit. One factor underlying the extent of plant injury is the amount of actual copper administered to the plant in a given application. Because the copper-containing compounds of the invention are chelates, such as HMTBA-Cu, that are relatively stable and release copper ions over a relatively prolonged duration of time, the compounds may be formulated for controlled release applications. In this manner, the amount of copper ion administered to the plant in any given application may be significantly lower (i.e., minimizing the risk of damage to the plant), while the total amount of copper ion administered over time may be enough to provide the antimicrobial benefit. The copper-containing compounds of the invention may be formulated for controlled release according to methods generally known in the art or as detailed herein.

In an additional exemplary embodiment, certain metal chelate compounds of the invention provide a source of “fixed” copper compounds. In this context, “fixed copper” refers to a form of copper compound in which the copper is in a chelated or complexed form. The resultant chemical is relatively insoluble compared to other copper compounds, such as copper sulfate. In an exemplary embodiment, for example, HMTBA-Cu and mixtures including this compound as well as HMBTA-Zn, may be used in applications suitable for use of fixed copper. These applications, for example, include formulations utilized for fruit crops (e.g., fruit trees), vegetable crops, and ornamental crops. An exemplary formulation for this application is for dusting plants with a powder containing the copper-containing compound. Formulations for powder may be accomplished by methods generally known in the art or as detailed herein.

It is envisioned that the active compound(s) may be combined with one or more agents that are conventionally employed in the formulation of agricultural and horticultural compositions. The compositions of this invention, including concentrates that require dilution prior to application, typically may contain at least one active compound and an adjuvant in liquid or solid form. The compositions may be prepared by admixing the active compounds with or without an adjuvant plus diluents, extenders, carriers, and conditioning agents to provide compositions in the form of wettable powder, dust, aerosol, microcapsules, finely-divided particulate solids, granules, pellets, solutions, dispersions or emulsions. In one exemplary embodiment, the composition will be in the form of a dust or powder for use in dusting the plant with a composition of the invention, such as by crop dusting. In another embodiment, the active compounds may be mixed with an adjuvant such as a finely divided solid, a liquid of organic origin, water, a wetting agent, a dispersing agent, an emulsifying agent or any suitable combination of these agents.

A variety of suitable solid, liquid, and gaseous carriers may be utilized in the compositions of the invention. Suitable solid carriers include, for example, fine powders or granules of clays (e.g. kaolin clay, diatomaceous earth, synthetic hydrated silicon dioxide, attapulgite clay, bentonite and acid clay), talcs, other inorganic minerals (e.g. sericite, powdered quartz, powdered sulfur, activated carbon, calcium carbonate and hydrated silica), and salts for chemical fertilizers (e.g. ammonium sulfate, ammonium phosphate, ammonium nitrate, urea and ammonium chloride). Suitable liquid carriers include, for example, water, alcohols (e.g. methanol and ethanol), ketones (e.g. acetone, methyl ethyl ketone and cyclohexanone), aromatic hydrocarbons (e.g. benzene, toluene, xylene, ethylbenzene and methylnaphthalene), aliphatic hydrocarbons (e.g. hexane and kerosene), esters (e.g. ethyl acetate and butyl acetate), nitriles (e.g. acetonitrile and isobutyronitrile), ethers (e.g. dioxane and diisopropyl ether), acid amides (e.g. dimethylformamide and dimethylacetamide), and halogenated hydrocarbons (e.g. dichloroethane, trichloroethylene and carbon tetrachloride). Suitable gaseous carriers include, for example, butane gas, carbon dioxide, and fluorocarbon gas.

In one embodiment, the formulation will include a wetting agent (i.e., also known as a surfactant). Typically, a suitable wetting agent will enhance the contact and uptake of the active compounds by the plant via a variety of mechanisms such as by causing increased spreading and retention of the active compound(s). A variety of wetting agents of the cationic, anionic or non-ionic type may be used. Non-limiting examples of wetting agents suitable for use include alkyl benzene and alkyl naphthalene sulfonates, alkyl and alkyl aryl sulfonates, alkyl amine oxides, alkyl and alkyl aryl phosphate esters, organosilicones, fluoro-organic wetting agents, alcohol ethoxylates, alkoxylated amines, sulfated fatty alcohols, amines or acid amides, long chain acid esters of sodium isothionate, esters of sodium sulfosuccinate, sulfated or sulfonated fatty acid esters, petroleum sulfonates, sulfonated vegetable oils, ditertiary acetylenic glycols, block copolymers, polyoxyalkylene derivatives of alkylphenols (particularly isooctylphenol and nonylphenol) and polyoxyalkylene derivatives of the mono-higher fatty acid esters of hexitol anhydrides (e.g., sorbitan). In an exemplary embodiment, the wetting agent may be an ethoxylated sorbitan, ethoxylated fatty acid, polysorbate-80, glycerol oleate, oleate salts, coconate salts, laurelate salts and suitable combinations of any of these wetting agents.

In another embodiment, the composition may include a dispersant. Examples of dispersant include methyl, cellulose, polyvinyl alcohol, sodium lignin sulfonates, polymeric alkyl naphthalene sulfonates, sodium naphthalene sulfonate, polymethylene bisnaphthalene sulfonate, and neutralized polyoxyethylated derivatives or ring-substituted alkyl phenol phosphates. Stabilizers may also be used to produce stable emulsions, such as magnesium aluminum silicate and xanthan gum.

The active compounds may also be formulated as a spray in the form of an aerosol. When formulated as an aerosol spray, the formulation is generally charged in a container under pressure together with a propellant. Examples of suitable propellants include fluorotrichloromethane or dichlorodifluoromethane.

The concentration of total active compound(s) present in the composition of the invention may vary considerably depending upon its intended use and formulation. Typically, the concentration of active compound(s) present in the composition may range from about 0.1% to about 100% by weight. In another embodiment, the concentration may be from about 40% to about 95% by weight. In still another embodiment, the concentration may be from about 50% to about 90% by weight. In a further embodiment, the concentration may be from about 60% to about 80% by weight. In still another embodiment, the concentration may be from about 65% to about 75% by weight. In an exemplary embodiment, the active compound(s) are in the form of the concentrates such as wettable powder, liquid preparations and emulsifiable concentrate that may contain the active compound(s) in an amount of 0.1 to 100% by weight and usually of 2 to 75% by weight based on the whole weight of the composition. These preparations may be diluted with any of the liquid carriers delineated above or otherwise known in the art, such as with water, upon use to give an aqueous preparation containing 0.0001 to 10% by weight of the active compound(s). The powders and granules may contain 0.1% to 10% by weight of the active compound(s).

By way of non-limiting example, when the active compound is ethoxyquin, it may be present in the composition at a concentration ranging from about 40% to about 95% by weight. In still another embodiment, the ethoxyquin concentration may be from about 50% to about 90% by weight. In a further embodiment, the ethoxyquin concentration may be from about 60% to about 80% by weight. In still another embodiment, the ethoxyquin concentration may be from about 65% to about 75% by weight.

By way of further non-limiting example, when the active compounds include ethoxyquin in combination with a metal chelate of HMTBA, such as HMTBA-Zn or HMTBA-Cu, the concentration may be from about 30% to about 40% by weight of ethoxyquin and from about 1% to about 5% by weight. HMTBA-Cu. In an additional embodiment, the concentration of ethoxyquin is about 37% by weight and the concentration of the metal chelate of HMTBA is about 2% by weight. In an exemplary embodiment, the metal chelate is HMTBA-Cu.

In an exemplary embodiment, where applicable, the composition may optionally include any of the wetting agents detailed above or otherwise known in the art. Typically, the wetting agent may be present at a concentration of from about 1% to about 15% by weight. In another embodiment, the wetting agent may be present at a concentration of from about 3% to about 12% by weight. In an additional embodiment, the wetting agent may be present at a concentration of from about 5% to about 9% by weight.

(d) Combinations with other Actives Agents

Yet another aspect of the invention provides combinations of the anti-phytopathogenic microbial compositions admixed with insecticides, another fungicides, bactericides, herbicides, plant-growth regulators and others. In some cases, synergism can be expected by the combined use of the active compound(s) of this invention with the other agents.

In one embodiment, the active compound(s) of the invention may be admixed with another fungicide or bactericide. As will be appreciated by a skilled artisan, the choice of additional fungicides or bactericides can and will vary depending upon the plant and the microbial target. Suitable non-limiting examples of fungicides and bactericides that may be used in admixture with the active compound(s) of this invention include the following: carbamate fungicides such as 3,3′-ethylenebis(tetrahydro-4,6-dimethyl-2H-1,3,5-thiadiazine-2-thione), zinc or manganese ethylenebis(dithiocarbamate), bis(dimethyldithiocarbamoyl)disulfide, zinc propylenebis(dithiocarbamate) bis(dimethyldithiocarbamoyl)ethylenediamine; nickel dimethyldithiocarbamate, methyl 1-(butylcarbamoyl)-2-benzimidazolecarbamate, 1,2-bis(3-methoxycarbonyl-2-thioureido)benzene, 1-isopropylcarbamoyl-3-(3,5-dichlorophenyl)hydantoin, potassium N-hydroxymethyl-N-methyldithiocarbamate and 5-methyl-10-butoxycarbonylamino-10,11-dehydrodibenzo (b,f)azepine; pyridine fungicides such as zinc bis(1-hydroxy-2(1H)pyridinethionate) and 2-pyridinethiol-1-oxide sodium salt; phosphorus fungicides such as O,O-diisopropyl S-benzylphosphorothioate and O-ethyl S,S-diphenyldithiophosphate; phthalimide fungicides such as N-(2,6-diethylphenyl)phthalimide and N-(2,6-diethylphenyl)-4-methylphthalimide; dicarboxyimide fungicides such as N-trichloromethylthio-4-cyclohexene-1,2-dicarboxyimide and N-tetrachloroethylthio-4-cyclohexene-1,2-dicarboxyimide; oxathine fungicides such as 5,6-dihydro-2-methyl-1,4-oxathine-3-carboxanilido-4,4-dioxide and 5,6-dihydro-2-methyl-1,4-oxathine-3-carboxanilide; naphthoquinone fungicide such as 2,3-dichloro-1,4-naphthoquinone, 2-oxy-3-chloro-1,4-naphthoquinone copper sulfate; pentachloronitrobenzene; 1,4-dichloro-2,5-dimethoxybenzene; 5-methyl-s-triazol (3,4-b)benzthiazole; 2-(thiocyanomethylthio)benzothiazole; 3-hydroxy-5-methylisooxazole; N-2,3-dichlorophenyltetrachlorophthalamic acid; 5-ethoxy-3-trichloromethyl-1-2,4-thiadiazole; 2,4-dichloro-6-(O-chloroanilino)-1,3,5-triazine; 2,3-dicyano-1,4-dithioanthraquinone; copper 8-quinolinate, polyoxine; validamycin; cycloheximide; iron methanearsonate; diisopropyl-1,3-dithiolane-2-iridene malonate; 3-allyloxy-1,2-benzoisothiazol-1,1-dioxide; kasugamycin; Blasticidin S; 4,5,6,7-tetrachlorophthalide; 3-(3,5-dichlorophenyl)-5-ethenyl-5-methyloxazolizine-2,4-dione; N-(3,5-dichlorophenyl)-1,2-dimethylcyclopropane-1,2-dicarboxyimide; S-n-butyl-5′-para-t-butylbenzyl-N-3-pyridyldithiocarbonylimidate; 4-chlorophenoxy-3,3-dimethyl-1-(1H,1,3,4-triazol-1-yl)-2-butanone; methyl-D,L-N-(2,6-dimethylphenyl)-N-(2′-methoxyacetyl)alaninate; N-propyl-N-[2-(2,4,6-trichlorophenoxy)ethyl]imidazol-1-carboxamide; N-(3,5-dichlorophenyl)succinimide; tetrachloroisophthalonitrile; 2-dimethylamino-4-methyl-5-n-butyl-6-hydroxypyrimidine; 2,6-dichloro-4-nitroaniline; 3-methyl-4-chlorobenzthiazol-2-one; 1,2,5,6-tetrahydro-4H-pyrrolo[3,2,1-i,j]quinoline-2-one; 3′-isopropoxy-2-methylbenzanilide; 1-[2-(2,4-dichlorophenyl)-4-ethyl-1,3-dioxorane-2-ylmethyl]-1H,1,2,4-triaz ol; 1,2-benzisothiazoline-3-one; basic copper chloride; basic copper sulfate; N′-dichlorofluoromethylthio-N,N-dimethyl-N-phenylsulfamide; ethyl-N-(3-dimethylaminopropyl)thiocarbamate hydrochloride; piomycin; S,S-6-methylquinoxaline-2,3-diyldithiocarbonate; complex of zinc and manneb; di-zinc bis(dimethyldithiocarbamate) ethylenebis (dithiocarbamate) and glyphosate.

In an exemplary embodiment, when the microbial target is an agent causing Asian soybean rust, the fungicide combined with the active compound(s) of the present invention may include a chlorothalonil based fungicide, a strobilurin based fungicide, a triazole based fungicide and suitable combinations of these fungicides. Non-limiting examples of suitable strobilurin based fungicides include azoxystrobin, pyraclostrobin, or trifloxystrobin. Representative examples of triazole-based fungicides include myclobutanil, propiconazole, tebuconazol, and tetraconazole.

In another embodiment, the active compound(s) of the invention may be applied with a herbicide. Non-limiting examples of herbicides that may be used in combination with the active compound(s) of this invention include, without limitation, imidazolinone, acetochlor, acifluorfen, aclonifen, acrolein, AKH-7088, alachlor, alloxydim, ametryn, amidosulfuron, amitrole, ammonium sulfamate, anilofos, asulam, atrazine, azafenidin, azimsulfuron, BAS 620H, BAS 654 OOH, BAY FOE 5043, benazolin, benfluralin, benfuresate, bensulfuron-methyl, bensulide, bentazone, benzofenap, bifenox, bilanafos, bispyribac-sodium, bromacil, bromobutide, bromofenoxim, bromoxynil, butachlor, butamifos, butralin, butroxydim, butylate, cafenstrole, carbetamide, carfentrazone-ethyl, chlormethoxyfen, chloramben, chlorbromuron, chloridazon, chlorimuron-ethyl, chloroacetic acid, chlorotoluron, chlorpropham, chlorsulfuron, chlorthal-dimethyl, chlorthiamid, cinmethylin, cinosulfuron, clethodim, clodinafop-propargyl, clomazone, clomeprop, clopyralid, cloransulam-methyl, cyanazine, cycloate, cyclosulfamuron, cycloxydim, cyhalofop-butyl, 2,4-D, daimuron, dalapon, dazomet, 2,4 DB, desmedipham, desmetryn, dicamba, dichlobenil, dichlorprop, dichlorprop-P, diclofop-methyl, difenzoquat metilsulfate, diflufenican, dimefuron, dimepiperate, dimethachlor, dimethametryn, dimethenamid, dimethipin, dimethylarsinic acid, dinitramine, dinocap, dinoterb, diphenamid, diquat dibromide, dithiopyr, diuron, DNOC, EPTC, esprocarb, ethalfluralin, ethametsulfuron-methyl, ethofumesate, ethoxysulfuron, etobenzanid, fenoxaprop-P-ethyl, fenuron, ferrous sulfate, flamprop-M, flazasulfuron, fluazifop-butyl, fluazifop-P-butyl, fluchloralin, flumetsulam, flumiclorac-pentyl, flumioxazin, fluometuron, fluoroglycofen-ethyl, flupoxam, flupropanate, flupyrsulfuron-methyl-sodiu- m, flurenol, fluridone, flurochloridone, fluroxypyr, flurtamone, fluthiacet-methyl, fomesafen, fosamine, glufosinate-ammonium, glyphosate, glyphosinate, halosulfuron-methyl, haloxyfop, HC-252, hexazinone, imazamethabenz-methyl, imazamox, imazapyr, imazaquin, imazethapyr, imazosuluron, imidazilinone, indanofan, ioxynil, isoproturon, isouron, isoxaben, isoxaflutole, lactofen, lenacil, linuron, MCPA, MCPA-thioethyl, MCPB, mecoprop, mecoprop-P, mefenacet, metamitron, metazachlor, methabenzthiazuron, methylarsonic acid, methyldymron, methyl isothiocyanate, metobenzuron, metobromuron, metolachlor, metosulam, metoxuron, metribuzin, metsulfuron-methyl, molinate, monolinuron, naproanilide, napropamide, naptalam, neburon, nicosulfuron, nonanoic acid, norflurazon, oleic acid (fatty acids), orbencarb, oryzalin, oxadiargyl, oxadiazon, oxasulfuron, oxyfluorfen, paraquat dichloride, pebulate, pendimethalin, pentachlorophenol, pentanochlor, pentoxazone, petroleum oils, phenmedipham, picloram, piperophos, pretilachlor, primisulfuron-methyl, prodiamine, prometon, prometryn, propachlor, propanil, propaquizafop, propazine, propham, propisochlor, propyzamide, prosulfocarb, prosulfuron, pyraflufen-ethyl, pyrazolynate, pyrazosulfuron-ethyl, pyrazoxyfen, pyributicarb, pyridate, pyriminobac-methyl, pyrithiobac-sodium, quinclorac, quinmerac, quinoclamine, quizalofop, quizalofop-P, rimsulfuron, sethoxydim, siduron, simazine, simetryn, sodium chlorate, STS system (sulfonylurea), sulcotrione, sulfentrazone, sulfometuron-methyl, sulfosulfuron, sulfuric acid, tar oils, 2,3,6-TBA, TCA-sodium, tebutam, tebuthiuron, terbacil, terbumeton, terbuthylazine, terbutryn, thenylchlor, thiazopyr, thifensulfuron-methyl, thiobencarb, tiocarbazil, tralkoxydim, tri-allate, triasulfuron, triaziflam, tribenuron-methyl, triclopyr, trietazine, trifluralin, triflusulfuron-methyl, and vernolate.

In still another embodiment, the active compound(s) of the invention may be applied with an insecticide. Representative examples of suitable insecticides include the following: phosphoric insecticides such as O,O-diethyl O-(2-isopropyl-4-methyl-6-pyrimidinyl)phosphorothioate, O,O-dimethyl S-2-[(ethylthio)ethyl]phosphorodithioate, O,O-dimethyl O-(3-methyl-4-nitrophenyl)thiophosphate, O,O-dimethyl S—(N-methylcarbamoylmethyl)phosphorodithioate, O,O-dimethyl S—(N-methyl-N-formylcarbamoylmethyl) phosphorodithioate, O,O-dimethyl S-2-[(ethylthio)ethyl] phosphorodithioate, O,O-diethyl S-2-[(ethylthio)ethyl] phosphorodithioate, O,O -dimethyl-1-hydroxy-2,2,2-trichloroethylphophonate, O,O-diethyl-O-(5-phenyl-3-isooxazolyl)phosphorothioate, O,O-dimethyl O-(2,5-dichloro-4-bromophenyl)phosphorothioate, O,O-dimethyl O-(3-methyl-4-methylmercaptophenyl)thiophosphate, O-ethyl O-p-cyanophenyl phenylphosphorothioate, O,O-dimethyl-S-(1,2-dicarboethoxyethyl)phosphorodithioate, 2-chloro-(2,4,5-trichlorophenyl)vinyldimethyl phosphate, 2-chloro-1-(2,4-dichlorophenyl)vinyldimethyl phosphate, O,O-dimethyl O-p-cyanophenyl phosphorothioate, 2,2-dichlorovinyl dimethyl phosphate, O,O-diethyl O-2,4-dichlorophenyl phosphorothioate, ethyl mercaptophenylacetate O,O-dimethyl phosphorodithioate, S-[(6-chloro-2-oxo-3-benzooxazolinyl)methyl] O,O-diethyl phosphorodithioate, 2-chloro-1-(2,4-dichlorophenyl)vinyl diethylphosphate, O,O -diethyl O-(3-oxo-2-phenyl-2H-pyridazine-6-yl) phosphorothioate, O,O-dimethyl S-(1-methyl-2-ethylsulfinyl)-ethyl phophorothiolate, O,O-dimethyl S-phthalimidomethyl phosphorodithioate, O,O-diethyl S—(N-ethoxycarbonyl-N-methylcarbamoylmethyl)phosphorodithioate, O,O-dimethyl S-[2-methoxy-1,3,4-thiadiazol-5-(4H)-onyl-(4)-methyl] dithiophosphate, 2-methoxy-4H-1,3,2-benzooxaphosphorine 2-sulfide, O,O-diethyl O-(3,5,6-trichloro-2-pyridyl)phosphorothiate, O-ethyl O-2,4-dichlorophenyl thionobenzene phosphonate, S-[4,6-diamino-s-triazine-2-yl-methyl] O,O-dimethyl phosphorodithioate, O-ethyl O-p-nitrophenyl phenyl phosphorothioate, O,S-dimethyl N-acetyl phosphoroamidothioate, 2-diethylamino-6-methylpyrimidine-4-yl-diethylphosphorothionate, 2-diethylamino-6-methylpyrimidine-4-yl-dimethylphosphorothionate, O,O-diethyl O—N-(methylsulfinyl) phenyl phosphorothioate, O-ethyl S-propyl O-2,4-dichlorophenyl phosphorodithioate and cis-3-(dimethoxyphosphinoxy)N-methyl-cis-crotone amide; carbamate insecticides such as 1-naphthyl N-methylcarbamate, S-methyl N-[methylcarbamoyloxy]thioacetoimidate, m-tolyl methylcarbamate, 3,4-xylyl methylcarbamate, 3,5-xylyl methylcarbamate, 2-sec-butylphenyl N-methylcarbamate, 2,3-dihydro-2,2-dimethyl-7-benzofuranylmethylcarbamate, 2-isopropoxyphenyl N-methylcarbamate, 1,3-bis(carbamoylthio)-2-(N,N-dimethylamino)propane hydrochloride and 2-diethylamino-6-methylpyrimidine-4-yl-dimethylcarbamate; and another insecticides such as N,N-dimethyl N′-(2-methyl-4-chlorophenyl)formamidine hydrochloride, nicotine sulfate, milbemycin, 6-methyl-2,3-quinoxalinedithiocyclic S,S-dithiocarbonate, 2,4-dinitro-6-sec-butylphenyl dimethylacrylate, 1,1-bis(p-chlorophenyl) 2,2,2-trichloroethanol, 2-(p-tert-butylphenoxy)isopropyl-2′-chloroethylsulfite, azoxybenzene, di-(p-chlorophenyl)-cyclopropyl carbinol, di[tri(2,2-dimethyl-2-phenylethyl)tin]oxide, 1-(4-chlorophenyl)-3-(2,6-difluorobenzoyl) urea and S-tricyclohexyltin O,O -diisopropylphosphorodithioate.

In an additional embodiment, the active compound(s) of the invention may also be admixed with fertilizers such as a nitrogen-containing fertilizer or a phosphorous-containing fertilizer. By way of non-limiting example, the active compound(s) may be coated on granules of fertilizer by methods generally known in the art.

II. Methods of Treatment

The anti-phytopathogenic microbial compositions of the present invention may be used to treat a plant or its progeny against infestation by a broad spectrum of microorganisms. As detailed below, the compositions are generally effective against bacteria, yeast and fungi.

It is also envisioned that the composition may be applied to the plant or its progeny at various stages of its development. In this context, the term “plant” includes whole plants and parts thereof, including, but not limited to, shoot vegetative organs/structures (e.g., leaves, stems and tubers), roots, flowers and floral organs/structures (e.g., bracts, sepals, petals, stamens, carpels, anthers and ovules), seed (including embryo, endosperm, and seed coat) and fruit (the mature ovary), plant tissue (e.g., vascular tissue or ground tissue) and cells (e.g., guard cells or egg cells), and progeny of the plant or any of the aforementioned parts of the plant. In an exemplary embodiment, the application occurs during the stages of germination, seedling growth, vegetative growth, and reproductive growth. More typically, applications of the present invention occur during vegetative and reproductive growth stages.

The compositions of the invention, depending upon the plant and the microbial target, may generally be effective both as a protectant agent and as a curative agent. In this context, the composition may be applied to prevent infestation of the plant or its progeny before it occurs. Alternatively, the composition may be applied to treat a plant or its progeny after infestation has occurred. By way of example, the composition may be applied to a plant seed prior to planting to prevent microbial infestation of the seed. The composition may be applied to the soil at the time of planting or just before planting to prevent microbial infestation of the newly planted seed (i.e., as a preemergent). Alternatively, the composition may be applied to a plant after its germination or to the foliage of the plant after emergence to either treat or prevent microbial infestation (i.e., as a postemergent).

Typically, an effective amount of anti-phytopathogenic microbial composition is applied to a plant or its progeny by several methods generally known in the art. As will be appreciated by a skilled artisan, the amount of composition comprising an “an effective amount” can and will vary depending upon the plant and its stage of production, the microbial target, and environmental conditions. Generally speaking, for a typical application, the plant or its progeny is treated with an amount of the composition sufficient to provide a concentration of active ingredients from about 0.01 mg/kg to about 10% by weight. It is envisioned that the method may involve more than one application of the composition to the plant or its progeny. For example, the number of applications may range from about 1 to about 5 or more. The applications, as detailed herein, may be made at the same or different stages of the plant's life cycle.

Because the anti-phytopathogenic microbial compositions of the invention are generally effective against a broad spectrum of microbial targets, the compositions may be used to treat or prevent microbial infestation in a large number of plants or their progeny. The class of plants that may be treated by the method of the invention includes the class of higher and lower plants, including angiosperms (i.e., monocotyledonous and dicotyledonous plants), gymnosperms, ferns, horsetails, psilophytes, lycophytes, bryophytes, and multicellular algae. In a typical embodiment, the plant may be any vascular plant, for example monocotyledons or dicotyledons or gymnosperms, including, but not limited to alfalfa, apple, Arabidopsis, banana, barley, canola, castor bean, chrysanthemum, clover, cocoa, coffee, cotton, cottonseed, corn, crambe, cranberry, cucumber, dendrobium, dioscorea, eucalyptus, fescue, flax, gladiolus, liliacea, linseed, millet, muskmelon, mustard, oat, oil palm, oilseed rape, papaya, peanut, pineapple, ornamental plants, Phaseolus, potato, rapeseed, rice, rye, ryegrass, safflower, sesame, sorghum, soybean, sugarbeet, sugarcane, sunflower, strawberry, tobacco, tomato, turfgrass, wheat and vegetable crops such as lettuce, celery, broccoli, cauliflower, cucurbits; fruit and nut trees, such as apple, pear, peach, orange, grapefruit, lemon, lime, almond, pecan, walnut, hazel; vines, such as grapes, kiwi, hops; fruit shrubs and brambles, such as raspberry, blackberry, gooseberry; forest trees, such as ash, pine, fir, maple, oak, chestnut, popular; with alfalfa, canola, castor bean, corn, cotton, crambe, flax, linseed, mustard, oil palm, oilseed rape, peanut, potato, rice, safflower, sesame, soybean, sugarbeet, sunflower, tobacco, tomato, and wheat. More typically, the plant will be a crop plant, for example, forage crop, oilseed crop, grain crop, fruit crop, vegetable crop, fiber crop, spice crop, nut crop, turf crop, sugar crop, beverage crop, and forest crop. In an exemplary embodiment, the crop plant is a soybean plant or a wheat plant. Exemplary crop plants include, corn, cereals, barley, rye, rice, vegetables, clovers, legumes, soybeans, peas, alfalfa, sugar cane, sugar beets, tobacco, cotton, rapeseed (canola), sunflower, safflower, and sorghum.

The anti-phytopathogenic microbial compositions of the present invention find use in the control, prevention or treatment of a wide variety of plant pathogens, including fungi, yeast and bacteria. Generally speaking, plant pathogens can be classified by their life cycle in relation to a plant host, these classifications include, obligate parasites, facultative parasites, and facultative saprophytes. The compositions of the present invention can be used to control, prevent or treat infection from a wide array of plant pathogens that include obligate parasites, facultative parasites, and facultative saprophytes. By way of example fungi pathogens may include, but are not limited to the following: Ascomycete fungi such as of the genera Venturia, Podosphaera, Erysiphe, Monolinia, Mycosphaerella, and Uncinula; Basidiomycete fungi such as from the genera Hemileia, Rhizoctonia, and Puccinia; Fungi imperfecti such as the genera Botrytis, Helminthosporium, Rhynchosporium, Fusarium, Septoria, Cercospora, Alternaria, Pyricularia, and Pseudocercosporella; Oomycete fungi such as from the genera Phytophthora, Peronospora, Bremia, Pythium, and Plasmopara; as well as other fungi such as Phakopsora Pachyrhizi, P. meibomiae, Scleropthora macrospora, Sclerophthora rayissiae, Sclerospora graminicola, Peronosclerospora sorghi, Peronosclerospora philippinensis, Peronosclerospora sacchari and Peronosclerospora maydis, Physopella zeae, Cercospora zeae-maydis, Colletotrichum graminicola, Gibberella zeae, Exserohilum turcicum, Kabatiellu zeae, and Bipolaris maydis. Bacterial pathogens may include Pseudomonas syringae, Pseudomonas tabaci, and Erwinia stewartii; and mycoplasma, mycoplasma-like, rickettsia and rickettsia-like organisms (e.g., Pierce's disease, Alfalfa Dwarf, Phony Peach disease, Aster Yellows disease, Peach X-disease, corn stunt, and Peach Yellow disease). Particularly preferred pathogen targets include, but are not limited to: Puccinia, Rhizoctonia, GGT, stripe rust, Asian soybean rust (Phakopsora pachyrhizi and Phakopsora meibomiae), Fusarium species, Verticillium species, gray leaf spot, Phytophthora species and corn rust.

Accordingly, non-limiting examples of pathogenic-mediated diseases that may be controlled, prevented or treated by the anti-phytopathogenic microbial compositions of the invention, for example, include diseases of alfalfa plants such as root rot (Phytophora medicaginis, P. megasperma); diseases of rice plant such as rice blast (Pyricularia oryzae), Helminthosporium leaf blight (Helminthosporium oryzae, Cochliobolus miyabeanus), Bakanae disease (Gibberella fujikuroi), seedling blight (Rhizopus oryzae), sheath blight (Rhizoctonia solani); diseases of oat plants such as crown rust (Puccinia coronata); diseases of barley plants such as powdery mildew (Erysiphe graminis), scald (Rhynchsporium secalis), spot-blotch (Cochliobolus sativus), yellow mottleleaf (Helminthosporium gramineum, Pyrenophora gramineum), net blotch (Pyrenophra teres), stinking smut (Tilletia caries), loose smut (Ustilago nuda); diseases of wheat plants such as powdery mildew (Erysiphe graminis), glume-blotch (Leptosphaeria nodorum, Septoria nodorum), stripe rust (Puccinia striiformis), Typhula snow blight (Typhula incarnata), eye spot (Pseudocercosporella herpotrichoides), snow mold (Calonectria graminicola, Fusarium nivale), stem rust (Puccinia graminis), black snow blight (Typhula ishikariensis), scab (Gibberella zeae), leaf rust (Puccinia recondita, Puccinia triticina), stripe (Helminthosporium gramineum), stinking smut (Tilletia caries), speckled leaf blight (Septoria tritici), loose smut (Ustilago tritici); diseases of corn plants such as damping-off (Pythium debaryanum); diseases of rye such as purple snow mold (Fusarium nivale); diseases of potato plants such as late blight (Phytophthora infestans), diseases of tobacco plants such as downy mildew (Peronospora tabacina), foot rot (Phytophthora parasitica var), septoria blight (Cercospora nicotianae), mosaic disease (tobacco mosaic virus); diseases of sugar beet such as leaf spot (Cercospora beticola), damping-off (Pythium debaryanum, Rhizoctonia solani, Pythium aphanidermatum); diseases of kidney bean such as gray mold (Botrytis cinerea), sclerotinia seed rot (sclerotial rot) (Sclerotinia sclerotiorum), southern blight (Corticium rolfsii); diseases of broad bean such as powdery mildew (Erysiphe polygoni, Sphaerotheca fuliginea), rust (Uromyces fabae, Uromyces phaseoli), gray mold (Botrytis cinerea); and diseases peanuts such as Ascochyta spot (Mycosphaerella arachidicola).

In a further embodiment, any of the copper-containing compositions of the invention may be utilized to control, prevent, or treat the plant diseases detailed in Table B.

TABLE B

| | DISEASE | |
|---|---|---|
| PLANT | COMMON NAME | PATHOGEN |
| Almond | Shot hole | Clasterosporium |
| | | carpophilum |
| | Rust | Puccinia prunispinosae |
| | Blossom wilt | Sclerotinia laxa and |
| | | Sclerotinia fructigena |
| | Leaf curl | Taphrina deformans |
| Aloe | Anthracnose | Colletotrichum agaves |
| Antirrhinum | Rust | Puccinia antirrhini |
| Apple | Pink disease | Corticium salmonicolor |
| | Fireblight | Erwinia amylovora |
| | Bitter rot | Glomerella cingulata |
| | Canker | Nectria galligena |
| | Blotch | Phyllosticta solitaria |
| | Black rot | Physalospora obtusa |
| | Blossom wilt | Sclerotinia laxa |
| | Scab | Venturia inaequalis |
| Apricot | Shot hole | Clasterosporium |
| | | carpophilum |
| | Rust | Puccinia prunispinosae |
| | Blossom wilt | Sclerotinia laxa and |
| | | Sclerotinia fructigena |
| Areca Nut | Thread blight | Corticium koleroga |
| Arrowroot | Banded leaf blight | Corticium solani |
| Artichoke | | Ramularia cynarae |
| (Globe) | | |
| Asparagus | Rust | Puccinia asparagi |
| Avocado | Fruit spot | Cercospora purpurea |
| | Anthracnose (Black | Glomerella cingulata |
| | spot) | |
| | Bacterial rot | Pseudomonas |
| | | syringae |
| | Scab | Sphaceloma perseae |
| Azalea | Flower spot | Ovulinia azaleae |
| Banana | Black rot (Die back) | Botryodiplodia |
| | | theobromae |
| | Helminthosporiosis | Helminthosporium sp. |
| | Sigatoka disease | Mycosphaerella |
| | (Leaf spot) | musicola |
| Barley | Snow damage | Typhula itoana |
| | Covered smut | Ustilago hordei |
| Bean (Broad) | Leaf spot | Asochyta pisi |
| | Chocolate spot | Botrytis cinerea |
| | Rust | Uromyces fabae |
| Bean (French | Anthracnose | Colletotrichum |
| and Runner) | | lindemuthianum |
| | Powdery mildew | Erysiphe polygoni |
| | Halo blight | Pseudomonas |
| | | medicaginis var |
| | | phaseolicola |
| | Rust | Uromyces |
| | | appendiculatus |
| | Common blight | Xanthomonas phaseoli |
| Begonia | Mildew | Oidium begoniae |
| Betel | Leaf spot | Bacterium betle |
| | Leaf spot | Glomeralla cingulata |
| | Foot rot | Phytophthora |
| | | colocasiae |
| | Leaf rot | Phytophthora |
| | | parasitica |
| Blackberry | Cane spot | Elsinoe veneta |
| Blueberry | Powdery mildew | Microsphaera alni var. |
| | | vaccinii |
| | Leaf rust | Pucciniastrum myrtilli |
| | Fruit rot | Sclerotinia vaccinii- |
| | | corymbosi |
| Brassicas | Damping off | Oipidium brassicae |
| | Downy mildew | Peronospora |
| | | parasitica |
| | Black leg (Canker) | Phoma lingam |
| | Black rot | Xanthomonas |
| | | campestris |
| Cacao | Brown pod rot (Die | Botryodiplodia |
| | back) | theobromae |
| | Witches' broom | Marasmius perniciosus |
| | Black pod rot | Phytophthora |
| | | palmivora |
| Calendula | Leaf spot | Cercospora |
| | | calendulae |
| Carnation | Ring spot | Didymellina dianthi |
| | Leaf spot | Septoria dianthi |
| | Rust | Uromyces dianthi |
| Carrot | Blight | Alternaria dauci |
| | Bacterial soft rot | Bacterium |
| | | carotovorum |
| | Leaf spot | Cercospora carotae |
| Cassava | Leaf spot | Cercospora henningsii |
| Castor oil | Leaf spot | Phyllosticta bosensis |
| Cattleya | Black rot | Phythium ultimum |
| Celery | Blight | Cercospora apii |
| | Leaf spot | Septoria apii and |
| | | Septoria apii |
| | | graveolentis |
| Cherry | Shot hole | Clasterosporium |
| | | carpophilum |
| | Leaf spot | Coccomyces hiemalis |
| | Bitter rot | Glomerella cingulata |
| | Leaf scorch | Gnomonia |
| | | erythrostoma |
| | Bacterial canker | Pseudomonas morsprunorum |
| | Brown rot (Blossom | Sclerotinia laxa and |
| | wilt) | Sclerotinia fructigena |
| | Scab | Venturia cerasi |
| Chestnut | Blight | Endothia parasitica |
| | Ink disease | Phytophthora |
| | | cambivora |
| Chilli | Blight (Leaf spot) | Cercospora capsici |
| | Blight (Collar rot) | Phytophthora capsici |
| | Bacterial spot | Xanthomonas |
| | | vesicatoria |
| Chrysanthemum | Mildew | Oidium chrysanthemi |
| | Rust | Puccinia chrysanthemi |
| | Leaf spot | Septoria |
| | | chrysanthemella |
| Cinchona | Damping off | Pythium vexans |
| Cineraria | | Alternaria senecionis |
| Citronella | Collar rot | |
| Citrus | Sooty mould | Aithaloderma citri |
| | Thread blight | Corticium koleroga |
| | Melanose | Diaporthe citri |
| | Mal secco | Deuterophoma |
| | | tracheiphila |
| | Scab | Elsinoe fawcetti |
| | Anthracnose (Wither | Gloeosporium |
| | tip) | limetticola |
| | Sooty blotch | Leptothyrium pomi |
| | Black spot | Phoma citricarpa |
| | Brown rot | Phytophthora spp. |
| | Black pit | Pseudomonas |
| | | syringae |
| | Septoria spot | Septoria depressa |
| | Canker | Xanthomonas citri |
| Coffee | Brown eyespot | Cercospora coffeicola |
| | Thread blight (Black | Corticium koleroga |
| | rot) | |
| | Anthracnose (Die | Glomerella cingulata |
| | back) | |
| | Rust | Hemileia vastatrix |
| | Berry disease | Colletotrichum |
| | | coffeanum |
| Conifers | Blight | Cercospora thujina |
| | Coryneum blight | Coryneum berckmanii |
| | Canker | Coryneum cardinale |
| | Fusiform rust | Cronartium fusiforme |
| | Blister rust | Cronartium ribicola |
| | Leaf cast (of Kauri | Hendersonula agathi |
| | Pine) | |
| | Needle cast (of | Lophodermium pinastri |
| | Scots Pine) | |
| | Phomopsis blight | Phomopsis |
| | | juniperovora |
| | Needle cast (of | Rhabdocline |
| | Douglas Fir) | pseudotsugae |
| | Root rot | Rhizoctonia crocorum |
| Cotton | Alternarii disease | Alternaria gossypii and |
| | | Alternaria |
| | macrospora | |
| | Sore shin | Corticium solani |
| Cowpea | Scab | Cladosporium vignae |
| Cucurbits | Leaf blight | Alternaria cucumerina |
| | Wet rot | Choanephora |
| | | cucurbitarum |
| | Anthracnose | Colletotrichum |
| | | lagenarium |
| | Wilt | Erwinia tracheiphila |
| | Powdery mildew | Ervsiphe |
| | | cichoracearum |
| | Black rot | Mycosphaerella |
| | | citrullina |
| | Stem end rot | Physalospora rhodina |
| | Downy mildew | Pseudoperonospora |
| | | cubensis |
| Currant (Ribes) | Leaf spot | Mycosphaerella |
| | | grossulariae and |
| | | Mycosphaerella ribis |
| | Leaf spot | Pseudopeziza ribis |
| Cytisus | Die back | Ceratophorum |
| | | setosum |
| Daffodil | White mould | Ramularia |
| | | vallisumbrosae |
| | Fire | Sclerotinia polyblastis |
| Dahlia | Leaf spot | Phyllosticta dahliicola |
| | | and Entyloma dahliae |
| Dalo | Leaf spot | Phytophthora |
| | | colocasiae |
| Delphinium | Mildew | Erysiphe polygoni |
| Derris | Leaf spot | Colletotrichum derridis |
| Dogwood | Spot anthracnose | Elsinoe corni |
| (Cornus) | | |
| Egg Plant | Leaf spot | Ascochyta |
| | | melongenae |
| | Damping off | Corticium solani |
| Fig | Leaf fall and Fruit rot | Cercospora bolleana |
| | Rust | Cerotelium fici |
| | Thread blight | Corticium koleroga |
| | Canker | Phomopsis |
| | | cinerescens |
| | Blight | Phizoctonia |
| | | microsclerotia |
| Filbert | Bud blight | Xanthomonas corylina |
| Fruit trees | Crown gall | Bacterium tumefaciens |
| Gambier | White root rot | Fomes lignosus |
| Gardenia | Canker | Phomopsis gardenia |
| Gerbera | Leaf spot | Cercospora sp. |
| Ginseng | Blight | Alternaria panax |
| Gladiolus | Corm rot | Botrytis gladiolorum |
| Gooseberry | Die back | Botrytis cinerea |
| | Leaf spot | Mycosphaerella |
| | | grossulariae |
| | Cluster cup rust | Puccinia |
| | | pringshemiana |
| | American mildew | Sphaerotheca morsuvae |
| Grasses | Snow mould | Calonectria |
| | | graminicola |
| | Red thread | Corticium fusiforme |
| | Brown patch of | Rhizoctonia and |
| | lawns | Holminthosporium spp. |
| | Stripe smut | Ustilago striiformis |
| Ground nut | Leaf spot | Cercospora |
| | | arachidicola and |
| | | Cercospora personate |
| | Stem rot (Southern | Sclerotium rolfsii |
| | blight) | |
| Guava | Leaf spot | Cephaleuros mycoidea |
| | Thread blight | Corticium koleroga |
| | Rust | Puccinia psidii |
| Hellebore | | Coniothyrium hellebori |
| Hollyhock | Rust | Puccinia malvacearum |
| Hop | Downy mildew | Pseudoperonospora |
| | | humuli |
| | Powdery mildew | Sphaerotheca humuli |
| Hydrangea | Mildew | Oidium hortensiae |
| Leek | Mildew | Peronospora |
| | | destructor |
| | White tip | Phytophthora porri |
| Lettuce | Downy mildew | Bremia lactucae |
| | Ring spot | Marssonina |
| | | panattoniana |
| Lily | Blight | Botrytis elliptica |
| Maize | Downy mildew | Sclerospora |
| | | philippinensis |
| Mango | Red rust | Cephaleuros virescens |
| | Anthracnose | Colletotrichum |
| | | gloeosporioides |
| | Scab | Elsinoe mangiferae |
| | Bacterial black spot | Erwinia mangiferae |
| | Anthracnose | Gloeosporium |
| | | mangiferae |
| | Powdery mildew | Oidium mangiferae |
| Medlar | Scab | Venturia eriobotryae |
| Millet (Italian) | Smut | Ustilago crameri |
| Mushroom | White mould | Mycogone perniciosa |
| | Bacterial | Pseudomonas tolaasi |
| | blotch(Brown blotch) | |
| Nectarine | Shot hole | Clasterosporium |
| | | carpophilum |
| | Rust | Puccinia prunispinosae |
| | Blossom wilt | Sclerotinia laxa and |
| | | Sclerotinia fructigena |
| | Leaf curl | Taphrina deformans |
| Oats | Loose smut | Ustilago avanae |
| Olive | Leaf spot | Cycloconium |
| | | oleaginum |
| Onion | Downy mildew | Peronospora |
| | | destructor |
| Orchids | Fusarium | Macrophoma and |
| | | Diplodia spp. |
| Paeony | Blight | Botrytis peaoniae |
| | Bud death | Sphaeropsis paeonia |
| Palm (Palmyra) | Leaf spot | Pestalotia palmarum |
| Passion fruit | Brown spot | Alternaria passiflorae |
| | Grease spot | Pseudomonas |
| | | passiflorae |
| Pawpaw | Leaf spot | Ascochyta caricae |
| | Anthracnose (Fruit | Colletotrichum |
| | rot) | gloeosporioides |
| | Powdery mildew | Oidium caricae |
| | Hard rot | Phytophthora |
| | | parasitica |
| Peach | Shot hole | Clasterosporium |
| | | carpophilum |
| | Rust | Puccinia prunispinosae |
| | Blossom wilt | Sclerotinia laxa and |
| | | Sclerotinia fructigena |
| | Leaf curl | Taphrina deformans |
| Pear | Scab (America) | Cladosporium effusum |
| | Thread blight | Corticium koleroga |
| | Firebiiglit | Erwinia amylovora |
| | Bitter rot | Glomerella cingulata |
| | Leaf spot (Leaf | Mycosphaerella |
| | speck) | sentina |
| | Scab | Venturia pirina |
| Pecan | Scab | Cladosporium effusum |
| | Thread blight | Corticium koleroga |
| | Vein spot | Gnomonia nerviseda |
| | Liver spot | Gnomonia caryae var. |
| | | pecanae |
| Pepper(Red) | (See Chilli) | |
| Persimmon | Canker | Phomopsis diospyri |
| Pineapple | Heart or stern rot | Phytophthora |
| | | parasitica |
| Piper betle | (See Betel) | |
| Plantain | Black tip | Helminthosporium |
| | | torulosum |
| Plum | Shot hole | Clasterosporium |
| | | carpophilum |
| | Black rot | Dibotryon morbosum |
| | Bacterial canker | Pseudomonas morsprunorum |
| | Wilt | Pseudomonas |
| | | prunicola |
| | Rust | Puccinia prunispinosae |
| | Brown rot | Sclerotinia fructigena |
| | Blossom wilt | Sclerotinia laxa |
| | Watery rot (Pocket | Taphrina pruni |
| | plums) | |
| | Bacterial spot | Xanthomonas pruni |
| Poplar | | Septogloeum |
| | | populiperdun |
| Poppy | Downy mildew | Peronospora |
| | | arborescens |
| Potato | Early blight | Alternaria solani |
| | Grey mould | Botrytis cinerea |
| | Blight (Late blight) | Phytophthora infestans |
| | Dry rot | Sclerotium rolfsii |
| Quince | Brown rot | Sclerotinia fructigena |
| | Shot hole | Clasterosporium |
| | | carpophilum |
| Raspberry | Spur blight | Didymella applanata |
| | Cane spot | Elsinoe veneta |
| | (Anthracnose) | |
| | Cane wilt | Leptosphaeria |
| | | coniothyrium |
| Rhododendron | Leaf scorch (Bud | Pycnostysanus |
| | blast) | azaleae |
| Rhubarb | Downy mildew | Peronospora jaapiana |
| Rice | Brown spot | Ophiobolus |
| | | miyabeanus |
| | (Helmintliosporiosis) | |
| | Blast | Piricularia oryzae |
| Rose | Black spot | Diplocarpon rosae |
| | Downy mildew | Peronospora sparsa |
| | Rust | Phragmidium |
| | | mucronatum |
| | Leaf spot | Sphaceloma rosarum |
| | (Anthracnose) | |
| | Mildew | Sphaerotheca |
| | | pannosa |
| Rubber | American leaf | Dothidella ulei |
| | disease | |
| | White root rot | Fomes lignosus |
| | Leaf disease | Helminthosporium |
| | | heveae |
| | Stem disease | Pestalotia palmarum |
| | Abnormal leaf fall | Phytophthora |
| | | palmivora |
| Rye grass | Blind seed | Phialea temulenta |
| Safflower | Rust | Puccinia carthami |
| Seedlings | Damping off | Pythium debaryanum, |
| | | Pythium and |
| | | Rhizoctonia spp, |
| | | Sclerotinia |
| | | sclerotiorum, etc |
| Sorghum | Covered smut | Sphacelotheca sorghi |
| Spinach | Leaf spot | Heterosporium |
| | | variabile |
| | Downy mildew | Peronospora effusa |
| Spindle tree | Mildew | Oidium euonymijaponicae |
| Stock | Leaf spot | Alternaria raphani |
| Strawberry | Leaf spot | Mycosphaerella |
| | | fragariae |
| Sugar beet | Leaf spot | Cercospora beticola |
| | Downy mildew | Peronospora schactii |
| Sunflower | Rust | Puccinia helianthi |
| | Wilt | Sclerotinia |
| | | sclerotiorum |
| Sweet potato | Wilt | Fusarium spp. |
| Taro | Leaf spot | Phytophthora |
| | | colocasiae |
| Tea | Black rot (Die back) | Botryodiplodia |
| | | theobromae |
| | Red rust | Cephaleuros niycoidea |
| | Blister blight | Exobasidium vexans |
| | Grey blight | Pestalotia theae |
| Tobacco | Brown spot (Red | Alternaria longipes |
| | rust) | |
| | Leaf spot | Ascochyta nicotianae |
| | Frog eye | Cercospora nicotianae |
| | Blue mould (Downy | Peronospora tabacina |
| | mildew) | |
| | Wildfire | Pseudomonas |
| | | tabacum |
| Tomato | Early blight | Alternaria solani |
| | Leaf mould | Cladosporium fulvum |
| | Anthracnose | Colletotrichum |
| | | phomoides |
| | Fruit rot | Didymella lycopersici |
| | Mildew | Leveilluia taurica |
| | Fruit rot | Phytophthora capsici |
| | Foot rot | Phytophthora |
| | | cryptogea |
| | Blight (Late blight) | Phytophthora infestans |
| | Leaf spot | Septoria lycopersici |
| | Grey leaf spot | Stemphylium solani |
| | Bacterial spot | Xanthomonas |
| | | vesicatoria |
| Tuberose | Blight | Botrytis elliptica |
| Tung | Thread blight | Corticium koleroga |
| Veronica | | Septoria exotici |
| Vine (Grape) | “Coitre” | Coniothyrium |
| | | diplodiella |
| | Anthracnose | Elsinoe ampelina |
| | Black rot | Guignardia bidwellii |
| | Leaf spot | Isariopsis fuckelli |
| | Bitter rot | Melanconium |
| | | fuligineum |
| | Angular leaf spot | Mycosphaerella |
| | | angulata |
| | Downy mildew | Plasmopara viticola |
| | Totbrenner | Pseudopeziza |
| | | tracheiphila |
| | Powdery mildew | Uncinula necator |
| Vine (Sultana) | Sooty dew | Exosporium sultanae |
| Viola | Leaf spot | Centrospora acerina |
| Violet | Scab | Sphaceloma violae |
| Walnut | Ring spot | Ascochyta juglandis |
| | Anthracnose | Gnomonia leptostyla |
| | (Blotch) | |
| | Downy leaf spot | Microstroma juglandis |
| | Blight | Xanthomonas |
| | | juglandis |
| Wheat | Root rot | Gibberella zeae |
| | Rust | Puccinia spp. |
| | Snow damage | Pythium sp. |
| | Bunt | Tilletia caries and |
| | | Tilletia faetida |
| Willow | Black canker | Physalospora |
| | | miyabeana |
| | Scab | Venturia chlorospora |
| Zinnia | Wilt | Sclerotinia |
| | | sclerotiorum |

In an exemplary embodiment, anti-phytopathogenic microbial compositions of the invention are used to control, prevent or treat a variety of pathogen-mediated foliar plant diseases. By way of non-limiting example, such foliar plant diseases may include fungal diseases of cereals such as leaf rust (Puccinia recondite), stripe rust (Puccinia striformus), stem rust (Puccinia graminis) or dwarf leaf rust (Puccinia hordei) in wheat or barley; powdery mildew (Erysiphe graminis) in wheat and barley, leaf spot (Helminthosporium maydis) in rice, and brown spot (Cochliobolus setariae) in corn. In one exemplary embodiment, the disease is a soybean foliar disease such as bacterial blight (i.e., caused by Pseudomonas syringae glycinea), brown spot or Spetoria leaf spot (i.e., caused by Septoria glycines), or frogeye leaf spot (caused by Cercospora sojina). In an exemplary embodiment, the soybean foliar disease is Asian soybean rust (i.e., caused by Phakopsora Pachyrhizi and Phakopsora meibomiae).

For treatment of Asian soybean rust, it is contemplated that the anti-phytopathogenic microbial compositions of the invention may optionally include another fungicide having activity against Phakopsora Pachyrhizi or Phakopsora meibomiae. Suitable fungicides, for example, include chlorothalonil based fungicide, a strobilurin based fungicide, a triazole based fungicide and suitable combinations of these fungicides.

### DEFINITIONS

The term “chelating agent” is used in its broadest interpretation to mean a compound that binds to metal ions.

The term “curative agent” is an anti-microbial agent capable of substantially arresting growth of an existing microbial infection in plants.

The term “facultative parasites” include those parasites that generally survive as saprophytes on the products of other organisms, such as plants, or dead organisms but can become parasitic when the conditions are favorable.

The term “fixed copper” as used herein refers to a form of copper compound in which the copper ion is substantially fixed securely to the molecule. The resultant chemical is relatively insoluble compared to other copper compounds, such as copper sulfate.

“HMTBA” stands for 2-hydroxy-4(methylthio)butanoic acid.

The terms “infestation” and “infection” are used interchangeably herein to mean penetration and/or colonization of a plant by a pathogen.

The term “obligate parasites” include those parasites that can only survive and reproduce by obtaining nutrition from living plant cells. Examples of obligate fungal parasites of plants include, but are not limited to members of Uredinales (rusts), Ustilaginales (smuts and bunts), Erysiphales (powdery mildews), and Oomycetes (water molds and downy mildews).

The term “protectant agent” is an anti-microbial agent that forms a barrier to infection and substantially prevents spore germination and/or penetration of the plant surface by a microbe.

As various changes could be made in the above compounds, products and methods without departing from the scope of the invention, it is intended that all matter contained in the above description and in the examples given below, shall be interpreted as illustrative and not in a limiting sense.

### EXAMPLES

The following examples illustrate various embodiments of the invention.

### Example 1

### Determine the Appropriate Concentration of the Fungicidal Compounds and the Appropriate Wetting Agent

The effectiveness of several different fungicidal compounds to prevent rust on beans was compared. Each of the fungicidal compounds was applied at three different concentrations. The medium concentration was a 10-fold reduction from the high concentration, and the low concentration was a 100-fold reduction from the high concentration (Table 1). Each fungicidal compound was applied in solution with one of three different wetting agents: 1% v/v crop oil concentrate (COC), 0.125% v/v non-ionic surfactant (NIS), or 4% v/v Tween 20 (Tween), a non-ionic detergent. All of the wetting agents were aqueous and not oil based. Phytotoxicity, or plant damage, and the efficacy of compound in preventatively controlling rust on beans were determined. All of the compounds detailed in Table 1 are commercially available from Novus International, Saint Louis, Mo. (i.e., the compound abbreviated (A) is sold under the trade name ALIMET®; the composition abbreviated (ASD) is sold under the trade name ACTIVATE® Starter DA; the composition abbreviated (AUSD) is sold under the trade name ACTIVATE® US WD; the composition abbreviated (AUSL) is sold under the trade name ACTIVATE® Starter L; the compound abbreviated (C) is sold under the trade name MINTREX® Cu; the compound abbreviated (CPS) is a ethoxyquin and MINTREX® Cu blend; the compound abbreviated (SE) is an ethoxyquin emulsion; the compound abbreviated (T) is sold under the trade name TOXGUARD®, and the compound abbreviated (Z) is sold under the trade name MINTREX® Zn).

TABLE 1
Fungicidal compounds and concentrations tested.

| | High | Medium | Low |
|---|---|---|---|
| | Con- | Con- | Con- |
| | centration | centration | centration |
| Fungicidal Compound | (% v/v) | (% v/v) | (% v/v) |
| HMTBA (A) | 5 | 0.5 | 0.05 |
| Organic Acid Blend and | 1 | 0.1 | 0.01 |
| calcium salt of HMBTA (ASD) | | | |
| Organic Acid, Inorganic Acid | 5 | 0.5 | 0.05 |
| and HMTBA (AUSD) | | | |
| Organic acid and HMTBA | 3 | 0.3 | 0.03 |
| (AUSL) | | | |
| HMBTA-Cu (C) | 0.05 | 0.005 | 0.0005 |
| HMTBA-Cu and Ethoxyquin | 5 | 0.5 | 0.05 |
| blend (CSP) | | | |
| Ethoxyquin Emulsion (SE) | 5 | 0.5 | 0.05 |
| TOXGUARD ® (T) | 5 | 0.5 | 0.05 |
| HMTBA-Zn (Z) | 1.8 | 0.18 | 0.018 |
| Control | 0 | 0 | 0 |

Experimental Design. Randomized complete block with three replicates per treatment. The experimental unit was a soil filled plastic container with one bean plant.

Planting. A rust susceptible bean cultivar (Pinto “P114”) was pre-germinated by placing the seeds on moist paper towels inside plastic bags and incubating them in the dark at 27° C. for 72 hrs. The seeds were then transplanted into soil filled containers, with one bean plant per container.

Treatment. Approximately 5 days after seeding (i.e. the first leaf stage), the leaves were sprayed (using a hand held sprayer) until liquid was dripping off all leaves. For each run, a control with wetting agent alone and no fungicide was also included.

Inoculation. Twenty-four hours after fungicide treatment, the plants were sprayed with bean rust in a 30 mL solution (40 μL Tween 20/1000 mL distilled water) at a rate of 4 mg rust/12 bean plants. The beans were misted at 98% relative humidity for 24 hrs.

Phytotoxicity Rating. Phytotoxicity was analyzed on the day of pathogen inoculation for each treatment. The ratings were based on a 0-3 scale where 0=no effect, 1=mild, 2=moderate and 3=severe phytotoxicity. The types of damage that were observed included, chlorosis, tip burning, flecking, and necrotic spots.

Rust Ratings. Approximately 12 days after inoculation rust pustule diameter was determined using an ocular hand lens. Pustule ratings ranged from no evidence of infection (0%) to pustule diameters of 800 μm (100%), see Table 2. The severity of infection (pustule frequency/leaf) was also determined. Data are presented as % of the control, based on the comparison of the pustule diameters in control plants to pustule diameters in treated plants. The diameter of five pustules on each of the primary leaves was averaged to provide the average pustule diameter/plant (there was 1 plant/pot). Severity was determined from the average pustule frequency/leaf from the two primary leaves. These two methods assessed different aspects of rust biology. Pustule diameter evaluated the effects of the compound on fungal growth within the tissues. Severity evaluated the control of spore germination and plant infection (in the preventative studies) and the control of fungal growth in tissues (in the curative studies).

TABLE 2
Pustule Ratings.

| Rating (%) | Pustule diameter |
|---|---|
| 0 | no infection |
| 20 | fleck |
| 40 | pustule <300 μm |
| 60 | pustule 300–500 μm |
| 80 | pustule 500–800 μm |
| 100 | pustule >800 μm |

Results. Phytotoxicity levels were high (>40% phytotoxic) for five of the nine compounds when applied at the high concentrations (top plot, FIG. 1). At the medium concentrations, all but the compound CSP, had phytotoxicity levels similar to those observed under low concentrations (middle and bottom plots, FIG. 1). At low concentrations, little phytotoxicity (<26%) was observed (bottom plot, FIG. 1). The medium and low concentrations of the compounds were selected for further study because the levels of phytotoxicity were reasonable.

In the presence of the COC wetting agent, medium concentrations of ASD, AUSD, AUSL, C, SE, T, and Z significantly (P=0.05) decreased pustule diameter relative to control (top plot, FIG. 2). Low concentrations of AUSL, CSP, T, and Z, in the presence COC; significantly (P=0.05) decreased pustule diameter relative to control (bottom plot, FIG. 2). In the presence of Tween; medium concentrations of AUSL, CSP, and SE significantly (P=0.05) decreased pustule diameter relative to control (top plot, FIG. 2).

In the presence of the COC wetting agent, medium concentrations of ASD, CSP, and SE significantly (P=0.05) decreased the severity of infection relative to control (top plot, FIG. 3). At low compound concentrations with COC; severity was significantly (P=0.05) decreased for all compounds relative to control (bottom plot, FIG. 3).

The three wetting agents COC, NIS and Tween were compared to determine whether they affected phytotoxcicity or fungicidal activity of the compounds (FIG. 4). NIS was selected as the most appropriate wetting agent, because when averaged across compounds at high concentrations (top plot, FIG. 4), NIS resulted in significantly (P=0.05) lower phytotoxicity than either COC or Tween. At medium concentrations, there was no significant difference (P=0.05) in wetting agents (middle plot, FIG. 4). At low compound concentrations in the presence of NIS, however, phytotoxicity was about 5%, which was considered negligible. Although low concentrations of the compounds applied in the presence of COC reduced pustule diameter (bottom plot, FIG. 4), these solutions were considered too phytotoxic to use. Severity was significantly (P=0.05) lowered when low concentrations of the compounds were applied in solution with NIS, as compared to Tween (bottom plot, FIG. 4).

This phytotoxicity screen demonstrated that a medium concentration of the compounds can be applied with minimal phytotoxic effects. NIS proved to be the best surfactant with negligible phytotoxicity under moderate and low compound concentrations. Low concentrations of the compounds, in solution with NIS, significantly (P=0.05) reduced rust severity over those in solution with Tween. Therefore, due to the minimal phytotoxic effects and the potential of reduced rust severity that were observed when NIS was used as a wetting agent, NIS was selected as the most appropriate wetting agent.

### Example 2

### Preventive and Curative Control of Fungicidal Compounds on Rust in Beans

The efficacy of each fungicidal compound in preventing or curing rust in beans was determined by testing medium concentrations of the compounds in the presence of the wetting agent NIS.

The experimental design, planting, treatment, inoculation, and ratings were as described in Example 1, except that the timing of compound treatment and inoculation were changed for the curative trial, as detailed in Table 3.

TABLE 3
Timetable of activities presented in days after seeding.

| Activity | Preventive Trial | Curative Trial |
|---|---|---|
| Compound applied | 12 d | 14 d |
| Inoculated with rust | 13 d | 12 d |
| Rated | 25 d | 14 d |

Results. Preventive application of the compound CSP significantly reduced (P=0.05) rust pustule diameter. The prevention of rust by CSP was much greater than that observed with any of the other treatments (top plot, FIG. 5). CSP displayed significant phytotoxicity, however. In two of the three replicates, the leaves of plants treated with CSP were completely damaged (100% phytotoxicity), while in the third replicate there was 0% rust and 50% phytotoxicity, which was still higher than the other compounds.

Upon curative application of the compounds, there was no significant phytotoxic effect or control of rust (bottom plot, FIG. 5). (Note: CSP did not produce significant phytotoxic effects compared to the other compounds in this trial.

### Example 3

### Preventive and Curative Control of Fungicidal Compounds on Rust in Wheat

The efficacy of each fungicidal compound in preventing or curing rust in wheat was determined by testing medium concentrations of the compounds in the presence of the wetting agent NIS.

Experimental Design. Randomized complete block with three replicates per treatment. The experimental unit was a soil filled insert containing 6 wheat plants.

Planting. Ten wheat seeds of the susceptible wheat cultivar “Alliance” were seeded into a soil filled insert. Three days after emergence the plants were thinned to 6 plants/insert. Results were averaged across these 6 plants.

Treatment. Wheat plants were treated (using a hand held sprayer) with compound approximately 12 days after seeding (once the second leaf has fully emerged). The different timings of treatment for the two trials are detailed in Table 3. Non-treated controls were included in reach replicate.

Inoculation. At the appropriate time for each trial (see Table 3), a virulent isolate of Nebraskan wheat rust was sprayed in a 0.03 mL suspension of concentrated Soltrol at a rate of 4 mg rust/108 wheat plants. (This was a standard application rate for inoculating approximately 102 wheat plants (comprising 6 plants each of 16 differentials and a control). The wheat was misted at 98% relative humidity for 12 hrs.

Ratings. Rust was rated as described in Example 1. A rating of 3 pustule diameters on each of 6 wheat plants was averaged to provide the average pustule diameter/plant. Severity was determined from the average pustule frequency/leaf from the 6 plants.

Results. When preventive applications of the compounds were applied, the severity of rust was significantly lowered (P=0.05) with CSP, SE, and Z relative to the control (top plot, FIG. 6).

No significant control of rust was observed when the compound was applied curatively (bottom plot, FIG. 6). Overall the phytotoxicity (including the control) was higher for this trial. This was thought to be a result of environmental factors that influenced all the plants. Drying due to increased temperature or more direct sunlight due can increase natural leaf senescence and these attributes have a similar appearance (yellowing of the leaf) as phytotoxic effects.

These studies reveal that most of the compounds can be applied at a medium concentration using the wetting agent NIS.

### Example 4

### Effectiveness of CSP and SE to Prevent or Control Bean Rust

Based upon the results of the trials presented above, a new test was conducted that compared the efficacy of CSP and SE on preventing or curing rust on dry beans. Each fungicide was used at an intermediate concentration (0.5%). Each fungicidal was applied in solution with one of four different wetting agents: 1% v/v COC, 0.125% v/v NIS, 4% v/v Tween, or 100% Soltrol, an oil-based wetting agent.

The experimental design was similar to those described above in Example 1. The fungicides were applied 24 hr before the rust inoculation for the preventive application, and 48 hr after the rust inoculation for the curative application. Each combination of fungicide and wetting agent was applied to three replicates of dry beans. Compounds were sprayed onto bean leaves at the first trifoliate stage to the point of leaf run off. In each experiment a control with wetting agent alone was included. Phytotoxicity was determined as described above in Example 1, and is presented as % of the control.

Twelve days after inoculation, rust pustule diameter was determined using an ocular hand lens. Pustule ratings ranged from no evidence of infection=0%, to pustule diameters of 800 μm. Results are presented as % of the control based on the comparison of the control pustule diameter to the treated plant pustule diameter. Severity (pustule frequency/leaf) was also determined. The two methods assess different aspects of rust biology. Pustule diameter evaluated effects of the compound on fungal growth within the tissues, and severity evaluated control of spore germinations and plant infection (preventative studies) and control of fungal growth in tissues (curative studies).

The results of the preventive application of the two fungicides are shown in FIG. 7, and the results for the curative application are presented in FIG. 8. In general, SE had greater phytotoxicity, while CSP was more effective at preventing rust, as determine by size and frequency of the pustules. When analyzed across all treatment conditions, it appears that COC and NIS were the most effective wetting agents.

What is claimed is:

1. A method for treating infestation of a plant or its progeny by a phytopathogenic microorganism, the method comprising applying a metal chelate or a metal salt, the metal chelate or metal salt comprising metal ions and a hydroxy analog of methionine to the plant.

2. The method of claim 1, wherein the hydroxy analog of methionine is a compound having formula (II): 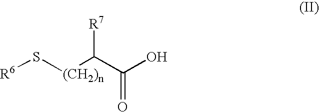
wherein:
n is an integer from 0 to 2;
R⁶ is methyl of ethyl; and
R⁷ is hydroxyl or amino.

3. The method of claim 1, wherein the hydroxy analog of methionine is 2-hydroxy-4(methylthio)butanoic acid.

4. The method of claim 1, wherein the metal ion is selected from the group consisting of zinc ions, copper ions, manganese ions, iron ions, chromium ions, nickel ions, cobalt ions, silver ions and calcium ions.

5. The method of claim 4, wherein the metal ion is a divalent ion selected from the group consisting of zinc, copper, and manganese.

6. The method of claim 1, wherein the metal chelate is a copper chelate of 2-hydroxy-4(methylthio)butanoic acid.

7. The method of claim 6, wherein the copper chelate of 2-hydroxy-4(methylthio)butanoic acid is in an aqueous composition and is present in the composition at a concentration of about 1% to about 5% by weight.

8. The method of claim 7, wherein the aqueous composition further comprises a surfactant selected from the group consisting of ethoxylated sorbitan, ethoxylated fatty acid, polysorbate-80, glycerol oleate, oleate salts, coconate salts, and laurelate salts.

9. The method of claim 8, wherein the concentration of surfactant present in the composition is from about 1% to about 15% by weight.

10. The method of claim 1, wherein the plant is selected from the group consisting of corn, cereals, barley, rye, rice, vegetables, clovers, legumes, soybeans, peas, alfalfa, sugar cane, sugar beets, tobacco, cotton, rapeseed, sunflower, safflower, and sorghum.

11. The method of claim 1, wherein the metal chelate is applied to a plant part selected from the group consisting of a leaf, vascular tissue, flower, root, stem, tuber, seed, and fruit.

12. The method of claim 1, wherein the phytopathogenic microorganism is selected from the group consisting of bacteria, fungi, and yeast.

13. The method of claim 1, wherein the plant is soybean or wheat, the metal chelate is applied to the leaf of the plant, and the phytopathogenic microorganism is a fungi.

14. The method of claim 1, wherein the phytopathogenic microorganism is Phakopsora pachyrhizi or Phakopsora meibomiae.

15. The method of claim 7, wherein the composition further comprises an agent selected from the group consisting of chlorothalonil based fungicide, a strobilurin based fungicide, a triazole based fungicide.

16. The method of claim 1, wherein metal chelate is formulated as a dry powder or as a dust.

17. The method of claim 16, wherein the metal chelate is applied by dusting the plant.

18. The method of claim 1, wherein the metal chelate is administered to the plant as a controlled release formulation.

19. The method of claim 1, wherein the metal chelate is formulated as at least a 90% (by weight) active, wettable flowable powder.

20. A method for treating a foliar fungal disease of a legume plant, the method comprising applying a copper chelate of 2-hydroxy-4(methylthio)butanoic acid to the leaves of the legume plant.

21. The method of claim 20, wherein the copper chelate of 2-hydroxy-4(methylthio)butanoic acid is in an aqueous composition and is present in the composition at a concentration of about 1% to about 5% by weight.

22. The method of claim 21, wherein the aqueous composition further comprises a surfactant selected from the group consisting of ethoxylated sorbitan, ethoxylated fatty acid, polysorbate-80, glycerol oleate, oleate salts, coconate salts, and laurelate salts.

23. The method of claim 22, wherein the concentration of surfactant present in the composition is from about 1% to about 15% by weight.

24. The method of claim 20, wherein the fugal disease is caused by a fungi selected from the group consisting of Phakopsora pachyrhizi, and Phakopsora meibomiae.

25. The method of claim 20, wherein the composition further comprises an agent selected from the group consisting of chlorothalonil based fungicide, a strobilurin based fungicide, a triazole based fungicide.

26. The method of claim 20, wherein the copper chelate of 2-hydroxy-4(methylthio)butanoic acid is formulated as a dry powder or as a dust.

27. The method of claim 20, wherein the copper chelate of 2-hydroxy-4(methylthio)butanoic acid is applied by dusting the plant.

28. The method of claim 20, wherein the copper chelate of 2-hydroxy-4(methylthio)butanoic acid is administered to the plant as a controlled release formulation.

29. The method of claim 20, wherein the copper chelate of 2-hydroxy-4(methylthio)butanoic acid is formulated as at least a 90% (by weight) active, wettable flowable powder.
